(19) United States
(12) Patent Application Publication
(10) Pub. No.: US 2008/0124645 A1
(43) Pub. Date: May 29, 2008

(54) Liquid Developer and Image Forming Apparatus

(75) Inventors: Shunichiro YAMANAKA, Komaki-shi (JP); Ken IKUMA, Suwa-shi (JP); Takashi TESHIMA, Shiojei-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/945,905

(22) Filed: Nov. 27, 2007

(30) Foreign Application Priority Data
Nov. 27, 2006 (JP) 2006-319339
Nov. 27, 2006 (JP) 2006-319340
Jun. 22, 2007 (JP) 2007-165602

(51) Int. Cl. G03G 9/125; G03G 15/10

(52) U.S. Cl. 430/115; 430/116; 399/237

(57) ABSTRACT

An insulating liquid used for a liquid developer containing toner particles, the insulating liquid includes a fatty acid triglyceride and a fatty acid monoester, the fatty acid triglyceride and the fatty acid monoester each containing an unsaturated fatty acid as a fatty acid component thereof, and an alcohol component constituting the fatty acid monoester having an alkyl group having from 1 to 8 carbon atoms.

### BACKGROUND

1. Technical Field

The present invention relates to an insulating liquid, a liquid developer, a process for producing a liquid developer, and an image forming apparatus.

2. Related Art

A developer for developing an electrostatic latent image formed on a latent image carrying member includes a dry toner used in a dry state constituted by a material containing a colorant, such as a pigment, and a binder resin, and a liquid developer (liquid toner) constituted by a toner dispersed in an electrically insulating carrier liquid (insulating liquid), as disclosed in Patent Document (JP-A-7-152256).

A method using a dry toner is advantageous owing to the use of a toner in a solid state, but has a concern of adverse influence of powder to a human body and has a problem in contamination due to scattering of the toner and unevenness upon dispersing the toner. A dry toner is liable to suffer aggregation, and the size of the toner particles is difficult to reduce, whereby a toner image having high resolution is difficult to form. In the case where the size of the toner particles is relatively small, the aforementioned problems due to the powder form of the toner conspicuously arise.

In a method using a liquid developer, the toner particles in the liquid developer are effectively prevented from being aggregated, whereby fine toner particles can be used, and a binder resin having a low softening point (softening temperature) can be used. Accordingly, the method using a liquid developer is advantageous in reproducibility of a thin line image, favorable in gradation reproducibility, and excellent in color reproducibility, and is suitable for a high-speed image forming method.

However, an insulating liquid having been used in a liquid developer is constituted mainly by a petroleum hydrocarbon, and has environmental issues, for example, in the case where the insulating liquid leaks outside an image forming apparatus.

A liquid developer has been produced by a dry pulverization method, in which a toner material is kneaded and pulverized to form toner particles, which are then mixed with and dispersed in an insulating liquid to obtain a liquid developer. In the dry pulverization method, however, it is difficult to reduce the particle diameter of the toner particles sufficiently, and the toner particles are liable to be fused to each other due to heat generated upon pulverization, whereby the toner particles formed are difficult to have a sufficiently small particle diameter. On the other hand, a wet pulverization method has been investigated, in which a toner material is pulverized (or crashed) in an insulating liquid to obtain a liquid developer having toner particles dispersed in the insulating liquid. In the wet pulverization method, the liquid that is used for pulverization (or crash) is used as an insulating liquid contained in the final liquid developer, and therefore, the production cost can be reduced as compared to the method for obtaining toner particles by pulverizing or crashing a toner material in a liquid that is necessarily distilled off finally. In the wet pulverization method, however, it has been difficult to obtain toner particles having a sufficiently small particle diameter (specifically, a particle diameter of 3 μm or less) due to the affinity between a resin material constituting the toner particles and the insulating liquid, and the viscosity of the insulating liquid.

### SUMMARY

Advantages of some aspects of the invention are to provide such an insulating liquid that is environmentally benign, to provide a liquid developer that is environmentally benign and contains toner particles having a sufficiently small particle diameter, to provide a process for producing the liquid developer, and to provide an image forming apparatus using the liquid developer and the insulating liquid.

According to an aspect of the invention, an insulating liquid used for a liquid developer containing toner particles is provided. The insulating liquid contains a fatty acid triglyceride and a fatty acid monoester. The fatty acid triglyceride and the fatty acid monoester each contains an unsaturated fatty acid as a fatty acid component thereof. An alcohol component constituting the fatty acid monoester has an alkyl group having from 1 to 8 carbon atoms.

It is preferred in the insulating liquid according to the aspect of the invention that the alcohol component has a linear alkyl group having from 1 to 7 carbon atoms.

It is preferred in the insulating liquid according to the aspect of the invention that the alcohol component has a branched alkyl group having from 3 to 8 carbon atoms.

It is preferred in the insulating liquid according to the aspect of the invention that the fatty acid monoester contains a product produced through ester exchange reaction between a natural fat or oil and a secondary alcohol or a tertiary alcohol.

It is preferred in the insulating liquid according to the aspect of the invention that the fatty acid monoester contains an unsaturated-fatty acid having from 14 to 22 carbon atoms as a fatty acid component.

It is preferred in the insulating liquid according to the aspect of the invention that a content X (% by weight) of the fatty acid triglyceride and a content Y (% by weight) of the fatty acid monoester in the insulating liquid satisfy relationship; 1≦X/Y≦19.

It is preferred in the insulating liquid according to the aspect of the invention that the insulating liquid further contains a hydrolysis inhibitor that inhibits hydrolysis of the fatty acid triglyceride and the fatty acid monoester.

It is preferred in the insulating liquid according to the aspect of the invention that the insulating liquid contains the hydrolysis inhibitor in an amount of from 0.01 to 5.0% by weight.

It is preferred in the insulating liquid according to the aspect of the invention that the hydrolysis inhibitor is a phenol phosphite compound.

According to another aspect of the invention, a liquid developer is provided that contains toner particles constituted mainly by a resin material and an insulating liquid. The insulating liquid contains a fatty acid triglyceride and a fatty acid monoester. The fatty acid triglyceride and the fatty acid monoester each contains an unsaturated fatty acid as a fatty acid component thereof. An alcohol component constituting the fatty acid monoester has an alkyl group having from 1 to 8 carbon atoms.

It is preferred in the liquid developer according to the aspect of the invention that the resin material constituting the toner particles has an acid value of from 0.1 to 15 mgKOH/g.

According to still another aspect of the invention, a process for producing a liquid developer is provided. The process contains a step of pulverizing and/or crashing toner particles in an insulating liquid that contains a fatty acid triglyceride and a fatty acid monoester. The fatty acid triglyceride and the fatty acid monoester each contains an unsaturated fatty acid as a fatty acid component thereof. An alcohol component constituting the fatty acid monoester has an alkyl group having from 1 to 8 carbon atoms.

According to a further aspect of the invention, an image forming apparatus is provided. The image forming apparatus contains: a liquid developer storing part that stores a liquid developer; a developing part that develops an image by using the liquid developer fed from the liquid developer storing part; a transferring part that transfers the image formed in the developing part, onto a recording medium to form a transferred image; a recovering part that recovers the liquid developer remaining in the developing part and/or the transferring part; a transporting part that transports the liquid developer recovered by the recovering part, to the liquid developer storing part; and a fixing part that fixes the transferred image formed on the recording medium, onto the recording medium. The liquid developer contains toner particles constituted mainly by a resin material and an insulating liquid. The insulating liquid contains a fatty acid triglyceride and a fatty acid monoester. The fatty acid triglyceride and the fatty acid monoester each contains an unsaturated fatty acid as a fatty acid component thereof. An alcohol component constituting the fatty acid monoester has an alkyl group having from 1 to 8 carbon atoms.

It is preferred in the image forming apparatus according to the aspect of the invention that the image forming apparatus further contains an insulating liquid replenishing part that replenishes the insulating liquid according to the aspect of the invention to the liquid developer storing part.

According to the aspects of the invention, an insulating liquid that is environmentally benign, a liquid developer that is environmentally benign and contains toner particles having a sufficiently small particle diameter, a process for producing the liquid developer, and an image forming apparatus using the liquid developer and the insulating liquid are provided.

### BRIEF DESCRIPTION OF THE DRAWINGS

The invention will be described with reference to the accompanying drawings, wherein like numbers reference like elements.

FIG. 1 is a cross sectional view showing an example of an image forming apparatus, to which a liquid developer according to an aspect of the invention is applied.

FIG. 2 is a perspective view showing an example of a line head exposing part of an image forming apparatus, to which a liquid developer according to an aspect of the invention is applied.

FIG. 3 is a cross sectional view in a subscanning direction showing the line head exposing part of an image forming apparatus, to which a liquid developer according to an aspect of the invention is applied.

FIG. 4 is a cross sectional view showing an example of a fixing device, to which a liquid developer according to an aspect of the invention is applied.

FIG. 5 is a schematic illustration showing an example of a second embodiment of an image forming apparatus, to which a liquid developer according to an aspect of the invention is applied.

FIG. 6 is an enlarged view showing a part of the image forming apparatus shown in FIG. 5.

FIG. 7 is a perspective conceptual view showing an example of a coating roller that the image forming apparatus shown in FIG. 5 equips.

FIG. 8 is an enlarged schematic illustration showing the coating roller shown in FIG. 7.

FIG. 9 is a schematic illustration showing an example of a state of toner particles in a liquid developer layer on a developing roller.

### DESCRIPTION OF EXEMPLARY EMBODIMENTS

The invention will be described in detail with reference to exemplary embodiments.

### Liquid Developer

An insulating liquid and a liquid developer according to aspects of the invention will be described.

The liquid developer according to an aspect of the invention contains an insulating liquid having dispersed therein toner particles.

### Insulating Liquid

The insulating liquid will be described.

The insulating liquid according to an aspect of the invention contains a fatty acid triglyceride and a fatty acid monoester each containing an unsaturated fatty acid as a fatty acid component thereof. An unsaturated fatty acid triglyceride referred herein means a fatty acid triglyceride that has at least one unsaturated fatty acid as a fatty acid component in the molecular structure.

A liquid developer has had environmental issues due to an insulating liquid used therein, such as leakage of the insulating liquid outside an image forming apparatus upon use (for example, evaporation of an insulating liquid upon fixing) and disposal of a used liquid developer. A liquid developer also has had a problem of impairing fixing property of toner particles to a recording medium (i.e., decrease in fixing strength) due to the insulating liquid attached to the surface of the toner particles.

On the other hand, a fatty acid triglyceride and a fatty acid monoester used in the insulating liquid according to an aspect of the invention are environmentally benign components. Accordingly, the environmental issues due to the insulating liquid used therein, such as leakage of the insulating liquid outside an image forming apparatus and disposal of a used liquid developer can be reduced. Consequently, an environmentally benign liquid developer can be provided.

The fatty acid triglyceride and the fatty acid monoester contain an unsaturated fatty acid component. The unsaturated fatty acid component is a component that contributes to improvement in fixing property of toner particles to a recording medium. More specifically, the unsaturated fatty acid component undergoes polymerization reaction through oxidation (oxidation upon fixing) and is cured by itself, whereby the fixing property of the toner particles can be improved through anchoring effect between the recording medium and the cured liquid developer. According to the mechanism, in the invention, excellent fixing property of the toner particles to the recording medium can be obtained. Furthermore, since the unsaturated fatty acid component is cured, a fixed toner image can be surely marked with a water-based ballpoint pen.

The fatty acid monoester contained in the insulating liquid permeates the resin particles (toner particles) in the fixing process to exhibit plasticizing effect. In the case where paper is used as the recording medium, for example, penetration of the toner particles into fibers of the paper is facilitated through the plasticizing effect, whereby the fixing strength of the toner particles is improved. Furthermore, the toner particles can be fixed at a lower temperature by the plasticizing effect.

The insulating liquid contains both the fatty acid triglyceride and the fatty acid monoester. Accordingly, upon storing, the toner particles are prevented from being aggregated with each other to provide excellent storage stability and long-term stability, and upon fixing, the fixing strength of the toner particles to the recording medium can be improved. The phenomena can be understood as follows. The fatty acid triglyceride and the fatty acid monoester contained in the insulating liquid are excellent in affinity with the resin material as the major component of the toner particles described later. Accordingly, the toner particles exhibit excellent dispersibility in the insulating liquid, and upon storing, aggregation (blocking) of the toner particles can be effectively prevented, whereby the liquid developer has excellent storage stability and long-term stability. Upon fixing, the liquid developer is applied with heat, whereby the fatty acid monoester permeates the toner particles to exhibit the plasticizing effect, and the toner particles can be firmly fixed on the recording medium thereby.

The use of the insulating liquid containing the fatty acid glyceride and the fatty acid monoester enables that the toner particles are fixed to the recording medium at a lower temperature, and particularly exhibit an excellent fixing strength. This can be understood as follows. In general, the fatty acid monoester has a lower viscosity as compared to the fatty acid triglyceride. Since the insulating liquid contains both the fatty acid glyceride and the fatty acid monoester, the insulating liquid and the liquid developer have an appropriate viscosity, whereby permeation of the liquid developer into the recording medium can be optimized. Furthermore, the insulating liquid containing the toner particles is cured through oxidation polymerization reaction of the unsaturated fatty acid component in the insulating liquid, whereby the toner particles can be firmly fixed to the recording medium through anchoring effect between the cured liquid developer and the recording medium.

The fatty acid monoester constituting the insulating liquid according to an aspect of the invention contains an alcohol component having an alkyl group having from 1 to 8 carbon atoms.

As a production process of the liquid developer, such a method has been investigated that contains a step of pulverizing or crashing a toner material (i.e., a composition constituting toner particles) in an insulating liquid to provide a liquid developer having toner particles dispersed in an insulating liquid. According to the process, a toner material is pulverized or crashed in a liquid, whereby heat can be suppressed from being generated upon pulverizing and crashing, and toner particles thus pulverized or crashed can be prevented from being aggregated and fused. Furthermore, since the liquid used for pulverizing or crashing is used as an insulating liquid that is contained in final liquid developer finally obtained, the production cost can be reduced as compared to the method for obtaining toner particles by pulverizing or crashing a toner material in a liquid that is necessarily distilled off finally. In the method, however, it has been difficult to obtain toner particles having a sufficiently small particle diameter due to affinity between the resin material constituting the toner particles and the insulating liquid, and the viscosity of the insulating liquid. For example, an aliphatic hydrocarbon liquid, which has been widely used as an insulating liquid contained in a liquid developer, is poor in affinity with a resin material constituting toner particles. Even in the case where the toner material is favorably pulverized or crashed in the liquid, particles obtained by pulverization or crashing are liable to be aggregated, and consequently, toner particles having a sufficiently small particle diameter cannot be obtained.

On the other hand, a fatty acid monoester contains an alcohol component having an alkyl group having from 1 to 8 carbon atoms is a component that is excellent in affinity with the resin material constituting the toner particles described later. Accordingly, upon pulverizing or crashing the toner material in an insulating liquid containing the component, particles thus obtained by pulverizing or crashing can be certainly suppressed from being aggregated. Furthermore, the insulating liquid containing the fatty acid monoester satisfying the condition and a fatty acid triglyceride has a suitable viscosity and particularly good affinity with the toner particles. Accordingly, the toner material can be favorably pulverized or crashed in the insulating liquid. Consequently, the toner material can be favorably pulverized or crashed in the insulating liquid, and the particles thus obtained by pulverizing or crashing can be certainly prevented from being aggregated, whereby toner particles having a sufficiently small particle diameter can be obtained. The liquid developer thus obtained also has performance that meets a demand of high resolution.

The aforementioned advantages are obtained by using the insulating liquid containing a fatty acid triglyceride and a fatty acid monoester containing an alcohol component having an alkyl group having from 1 to 8 carbon atoms. The advantages cannot be obtained if the insulating liquid lacks either one of the fatty acid triglyceride and the fatty acid monoester having the aforementioned characteristics. Specifically, in the case where the insulating liquid does not contain the fatty acid triglyceride, the fatty acid monoester, which has a low molecular weight and a low viscosity, is liable to permeate the resin material constituting the toner material upon pulverizing or crashing, whereby the particles thus obtained by pulverizing or crashing are liable to be aggregated. Consequently, the resulting toner particles cannot have a small diameter, and the liquid developer obtained contains coarse particles. In the case where the liquid developer does not contain the fatty acid monoester having the aforementioned characteristics, the insulating liquid is increased in viscosity, and the affinity between the toner material and the insulating liquid, which is necessary for favorably pulverizing or crashing the toner particles in the insulating liquid, cannot be maintained. Consequently, the toner particles cannot be favorably pulverized or crashed, and a liquid developer containing toner particles having a sufficiently small particle diameter cannot be obtained. In the case where the insulating liquid contains a fatty acid monoester, but the fatty acid monoester contains only an alcohol component having an alkyl group having 9 or more carbon atoms, the insulating liquid has a high viscosity to make favorable pulverization or crashing of the toner material difficult.

As having been described, the liquid developer according to an aspect of the invention contains an insulating liquid containing a fatty acid monoester containing an alcohol component having an alkyl group having from 1 to 8 carbon atoms, and in the case where the alkyl group of the fatty acid monoester satisfying the aforementioned conditions further satisfies the following conditions, further advantages shown below can be obtained.

In the case where the fatty acid monoester constituting the insulating liquid contains an alcohol component having a linear alkyl group having from 1 to 7 carbon atoms, the fatty acid monoester quickly permeates the toner particles upon application of heat in the fixing step, whereby plasticization effect is favorably exhibited. Accordingly, the liquid developer can be favorably used for image formation at high speed, in which it is demanded to fix toner particles to a recording medium in a short period of time, and the fixing strength thereof can be particularly improved.

In the case where the insulating liquid further contains a hydrolysis inhibitor described later in addition to the fatty acid triglyceride and the fatty acid monoester satisfying the aforementioned conditions, the liquid developer is particularly improved in storage stability, long-term stability and fixing property. The advantage can be considered as follows.

That is, a fatty acid monoester having a linear alkyl group as an alcohol component, which includes the fatty acid monoester having the aforementioned characteristics, is liable to be reacted (hydrolysis) with water present in the air or water contained in a slight amount in the insulating liquid, and thus decomposed into a fatty acid and an alcohol. In the case where a liquid developer contains a large amount of the decomposed fatty acid (free fatty acid), the free fatty acid permeates the toner particles upon storing. As a result, the toner particles undergo unintended aggregation, and the liquid developer is difficult to exhibit storage stability and long-term stability that are sufficient as a liquid developer. Furthermore, an insulating liquid containing an excessive amount of the free fatty acid is lowered in electric insulation, and upon developing with an image forming apparatus described later, the toner particles may be insufficiently attached to an electrostatic latent image, whereby a toner image with high definition and high image quality may not be obtained. In the case where the insulating liquid contains a hydrolysis inhibitor described later, on the other hand, the amount of the free fatty acid generated in the insulating liquid can be suppressed, and consequently, the liquid developer is particularly improved in all storage stability, long-term stability and fixing property.

In the case where the fatty acid monoester constituting the insulating liquid contains an alcohol component having a branched alkyl group having from 3 to 8 carbon atoms, the following advantages can be obtained.

As having been described above, the fatty acid monoester having a linear alkyl group generates a free fatty acid through reaction (hydrolysis) with water contained in the insulating liquid. On the other hand, the fatty acid monoester having a branched alkyl group having from 3 to 8 carbon atoms certainly exhibits the aforementioned plasticizing effect upon fixing, and also is suppressed from being hydrolyzed since the ester bond of the fatty acid monoester is prevented from coming close to water molecules through steric hindrance of the branched alkyl group. Accordingly, the amount of the free fatty acid generated in the insulating liquid can be favorably suppressed from being increased for a prolonged period of time. Consequently, the use of the insulating liquid constituting the liquid developer containing a combination of the fatty acid monoester and the fatty acid triglyceride particularly improves the liquid developer in all storage stability, long-term stability and fixing property.

The content of the fatty acid triglyceride in the insulating liquid is preferably from 55 to 95% by weight, and more preferably from 57 to 90% by weight. The liquid developer containing the liquid developer satisfying the conditions is particularly excellent in storage stability and long-term stability.

The content of the fatty acid monoester in the insulating liquid is preferably from 5 to 45% by weight, and more preferably from 10 to 43% by weight. According to the constitution, permeation of the fatty acid monoester into the toner particles upon fixing is further improved, whereby the plasticizing effect is surely exhibited. Consequently, the fixing property of the toner particles to a recording medium can be further improved.

The ratio of the fatty acid triglyceride and the fatty acid monoester having the aforementioned characteristics in the insulating liquid is not particularly limited and preferably satisfies the following relationship. The content X (% by weight) of the fatty acid triglyceride and the content Y (% by weight) of the fatty acid monoester in the insulating liquid preferably satisfy relationship, 1≦X/Y≦19, and more preferably satisfy relationship, 1.4≦X/Y≦9. According to the constitution, upon storing, the fatty acid monoester can be suitably suppressed from permeating the toner particles, and upon fixing, the fatty acid monoester sufficiently permeates the toner particles to provide the plasticizing effect surely. Consequently, the storage stability and the long-term stability of the liquid developer, and the fixing property of the toner particles to a recording medium can be further improved.

The insulating liquid preferably has an acid value of from 0.01 to 1.0 mgKOH/g, and more preferably from 0.02 to 0.5 mgKOH/g. According to the constitution, the liquid developer is particularly improved in storage stability and long-term stability. In the production process of the liquid developer described later, the material constituting the toner is pulverized or crashed with the fatty acid monoester and the fatty acid triglyceride described above. By using the insulating liquid satisfying the aforementioned conditions upon pulverizing or crashing, the toner material can be pulverized or crashed with high efficiency, whereby the production time of the toner particles can be reduced, and the particle diameter of the toner particles obtained becomes further uniform.

### Fatty Acid Triglyceride

The fatty acid triglyceride in the insulating liquid according to an aspect of the invention is a triester between a fatty acid and glycerin (i.e., a triglyceride), and contains an unsaturated fatty acid as a fatty acid component.

The fatty acid triglyceride in the insulating liquid contains an unsaturated fatty acid as a fatty acid component, whereby the toner particles can be firmly fixed to the recording medium while making the storage stability and the long-term stability of the liquid developer excellent. Examples of the unsaturated fatty acid component include a monobasic unsaturated fatty acid, such as oleic acid, palmitoleic acid and myristoleic acid, a polybasic unsaturated fatty acid having plural double bonds in the molecule, such as linoleic acid, α-linolenic acid, γ-linolenic acid, arachidonic acid, docosahexaenoic acid (DHA) and eicosapentaenoic acid (EPA), and a conjugated unsaturated fatty acid thereof.

Among the unsaturated fatty acid components described above, the monobasic unsaturated fatty acid particularly has excellent chemical stability. Accordingly, in the case where the fatty acid triglyceride in the insulating liquid contains the monobasic unsaturated fatty acid as a fatty acid component, the liquid developer is particularly improved in storage stability and long-term stability. The polybasic unsaturated fatty acid, on the other hand, has high reactivity (oxidation reactivity) as compared to the monobasic unsaturated fatty acid. Accordingly, in the case where the fatty acid triglyceride in the insulating liquid contains the polybasic unsaturated fatty acid as a fatty acid component, the oxidation polymerization reaction of the insulating liquid favorably proceeds upon fixing, whereby the toner particles can be firmly fixed to the recording medium.

In the case where the fatty acid triglyceride contains a saturated fatty acid as a fatty acid component, in addition to the unsaturated fatty acid, the chemical stability and the electric insulating property of the liquid developer can be maintained at high levels. Accordingly, the liquid developer can be prevented from suffering chemical change, and the electric resistance thereof can be maintained at a high level, whereby the storage stability and the long-term stability of the liquid developer can be improved. Examples of the saturated fatty acid include butyric acid, caproic acid, caprylic acid, capric acid, lauric acid, myristic acid, palmitic acid, stearic acid, arachidinic acid, behenic acid and lignoceric acid.

The fatty acid triglyceride can be obtained efficiently by purifying such a naturally-derived fat or oil as a fat or oil derived from vegetables, such as soybean oil, rapeseed oil, safflower oil, sunflower oil, linseed oil, olive oil, corn oil, camellia oil, cotton seed oil, dehydrated caster oil, palm kernel oil and coconut oil, and a fat or oil derived from animals, such as herring oil and sardine oil. Examples of the purification method include such a method in that an unpurified fat or oil is mixed with boiling water, and after completely separating the mixture into three layers, a component that freezes in a freezing chamber is removed. The method may be repeatedly carried out to provide the fatty acid triglyceride having higher purity.

The fatty acid triglyceride preferably contains a monobasic unsaturated fatty acid in an amount of from 5 to 80% by mol, and more preferably from 15 to 80% by mol, based on the total fatty acid components. According to the constitution, the storage stability and the long-term stability of the liquid developer can be particularly improved.

The fatty acid triglyceride preferably contains a polybasic unsaturated fatty acid in an amount of from 15 to 80% by mol, and more preferably from 20 to 70% by mol, based on the total fatty acid components. According to the constitution, the toner particles can be fixed to the recording medium further firmly.

The fatty acid triglyceride preferably contains a saturated fatty acid component in an amount of from 5 to 20% by mol, and more preferably from 10 to 18% by mol, based on the total fatty acid components. According to the constitution, the storage stability and the long-term stability of the liquid developer can be particularly improved.

### Fatty Acid Monoester

The fatty acid monoester in the insulating liquid according to an aspect of the invention is a monoester between a fatty acid and a monohydric alcohol, and contains an unsaturated fatty acid as a fatty acid component.

The fatty acid monoester preferably contains an unsaturated fatty acid having from 14 to 22 carbon atoms as a fatty acid component. According to the constitution, the unsaturated fatty acid monoester appropriately permeates the toner particles upon fixing, whereby the fatty acid monoester sufficiently exhibits effect of a plasticizer. Furthermore, the insulating liquid appropriately permeates the recording medium, and the liquid developer is appropriately cured through oxidation polymerization reaction. Owing to these advantages, the fixing property of the toner particles to the recording medium is particularly improved. Examples of the unsaturated fatty acid component include a monobasic unsaturated fatty acid, such as oleic acid, palmitoleic acid and myristoleic acid, a polybasic unsaturated fatty acid having plural double bonds in the molecule, such as linoleic acid, α-linolenic acid, γ-linolenic acid, arachidonic acid, docosahexaenoic acid (DHA) and eicosapentaenoic acid (EPA), and a conjugated unsaturated fatty acid thereof.

The fatty acid component of the fatty acid monoester contains mainly an unsaturated fatty acid and may contains partially a saturated fatty acid. Owing to this, the storage stability and the long-term stability of the insulating liquid are further improved. Examples of the saturated fatty acid include butyric acid, caproic acid, caprylic acid, capric acid, lauric acid, myristic acid, palmitic acid, stearic acid, arachidinic acid, behenic acid and lignoceric acid.

The fatty acid monoester is a monoester between a fatty acid and a monohydric alcohol, and the alcohol component constituting the fatty acid monoester has an alkyl group having from 1 to 8 carbon atoms. In the case where the insulating liquid contains the fatty acid monoester having the characteristics and the fatty acid triglyceride described above, the toner material can be favorably pulverized or crashed in the insulating liquid, the particles obtained by pulverizing or crashing are certainly prevented from being aggregated, thereby providing toner particles having a sufficiently small particle diameter. The liquid developer thus obtained sufficiently meets demands of high resolution. Examples of an alcohol having from 1 to 8 carbon atoms obtained through ester exchange with a naturally derived fat or oil (such as a fatty acid triglyceride) include an alcohol providing a linear alkyl group through ester exchange with a naturally derived fat or oil, such as methanol (C1), ethanol (C2), propanol (C3), butanol (C4), pentanol (C5), hexanol (C6), heptanol (C7) and octanol (C8), and an alcohol providing a branched alkyl group through ester exchange with a naturally derived fat or oil, such as isopropanol (C3), 2-butanol (C4), isobutanol (C4), tert-butanol (C4), 2-pentanol (C5), 3-pentanol (C5), 2,2-dimethyl-1-propanol (C5), 2-hexanol (C6), 3-methyl-3-pentanol (C6), 2,3-dimethyl-2-butanol (C6), 2-heptanol (C7), 2,4-dimethyl-3-pentanol (C7), 2-octanol (C8), 2-ethyl-1-hexanol (C8) and 1,1-diethyl-3-methyl-1-propanol (C8), and one or plural kinds selected from them can be used.

In the insulating liquid containing the fatty acid monoester containing an alcohol component that provides a linear alkyl group having from 1 to 7 carbon atoms through ester exchange with a naturally derived fat or oil among these alcohols, the fatty acid monoester contained permeates the toner particles upon fixing to exhibit the plasticizing effect favorably. Accordingly, the fixing property of the toner particles to a recording medium can be improved.

The aforementioned advantages can be obtained by using the fatty acid monoester containing an alcohol component having a linear alkyl group having from 1 to 7 carbon atoms, and the alkyl group preferably has from 1 to 5 carbon atoms, and more preferably from 1 to 3 carbon atoms. According to the constitution, the aforementioned advantages can be conspicuously exhibited.

In the case where the insulating liquid contains the fatty acid monoester containing an alcohol component that provides a branched alkyl group having from 3 to 8 carbon atoms through ester exchange with a naturally derived fat or oil among these alcohols, the following advantages can be obtained. The amount of the free fatty acid generated in the insulating liquid can be favorably suppressed from being increased for a prolonged period of time, and the liquid developer is improved in storage stability and long-term stability. Upon fixing, the fatty acid monoester permeates the toner particles to exhibit the plasticizing effect favorably. Accordingly, the toner particles are improved in fixing property to a recording medium.

In the case where the alcohol component constituting the fatty acid monoester has a branched alkyl group having from 3 to 8 carbon atoms, the alcohol is preferably a secondary alcohol or a tertiary alcohol. According to the constitution, a free fatty acid can be more favorably prevented from being generated in the insulating liquid, whereby the liquid developer is further improved in storage stability and long-term stability. It is considered this is because of the following factors. The alcohol component of the fatty acid monoester that is formed through ester exchange reaction of a secondary alcohol or a tertiary alcohol with a fatty acid has such a structure in that two or three alkyl groups are bonded to the carbon atom that is nearest the ester bond. It is considered that the branched alkyl group having the structure exhibits large steric hindrance in the vicinity of the ester bond, as compared to the linear alkyl group having only one alkyl group bonded to the carbon atom that is nearest the ester bond (i.e., the alcohol component of the fatty acid monoester formed through ester exchange reaction between a fatty acid and a primary alcohol), whereby the ester bond is prevented further effectively from coming close to water molecules through the steric hindrance. Accordingly, the aforementioned advantages can be obtained.

The aforementioned advantages can be obtained by using the fatty acid monoester containing an alcohol component having a branched alkyl group having from 3 to 8 carbon atoms, and the alkyl group preferably has from 3 to 5 carbon atoms. According to the constitution, the aforementioned advantages can be conspicuously exhibited.

The fatty acid monoester constituting the insulating liquid preferably formed through ester exchange reaction between the aforementioned fatty acid triglyceride and a monohydric alkyl alcohol having from 1 to 8 carbon atoms. According to the constitution, the toner particles in the liquid developer can have a sufficiently small particle diameter.

The fatty acid monoester preferably contains a fatty acid monoester constituted by a monobasic unsaturated fatty acid as a fatty acid component in an amount of from 10 to 75% by weight, and more preferably from 15 to 65% by weight, based on the total amount of the fatty acid monoester. According to the constitution, the storage stability and the long-term stability of the liquid developer can be particularly improved.

The fatty acid monoester preferably contains a fatty acid monoester constituted by a polybasic unsaturated fatty acid in an amount of from 15 to 80% by weight, and more preferably from 20 to 70% by weight, based on the total amount of the fatty acid monoester. According to the constitution, the toner particles can be fixed to the recording medium further firmly.

The fatty acid monoester preferably contains a fatty acid monoester constituted by a saturated fatty acid component in an amount of from 5 to 20% by weight, and more preferably from 10 to 18% by weight, based on the total amount of the fatty acid monoester. According to the constitution, the storage stability and the long-term stability of the liquid developer can be particularly improved.

The insulating liquid may contain a hydrolysis inhibitor having a function of suppressing hydrolysis of the fatty acid triglyceride and the fatty acid monoester.

In the case where the insulating liquid contains the hydrolysis inhibitor as a constitutional component, a free fatty acid can be effectively prevented from being generated from the fatty acid triglyceride and the fatty acid monoester. According to the constitution, the toner particles are improved in fixing property to a recording medium, and are prevented from undergoing unintended aggregation upon storing, and the liquid developer is improved in storage stability and long-term stability.

Examples of the function of the hydrolysis inhibitor include inhibition, termination and retardation of hydrolysis reaction of the fatty acid triglyceride and the fatty acid monoester, and recombination of a broken ester bond, which may have a function of suppressing finally the amount of the hydrolysis products (i.e., a free fatty acid and an alcohol) from being increased. Examples of the hydrolysis inhibitor include a phenol compound, such as 2,6-di-tert-butyl-p-cresol, pentaerythritol tetrakis(3-(3,5-di-tert-butyl-4-hydroxyphenyl)propionate), octadecyl-3-(3,5-di-tert-butyl-4-hydroxyphenyl)propionate, hexamethylene bis(3-(3,5-di-tert-butyl-4-hydroxyphenyl)propionate), benzenepropionic acid and 3,5-bis(1,1-dimethylethyl)-4-hydroxy-(C₇₋₉ side chain alkyl ester); a sulfur compound, such as thiodiethylene bis(3-(3,5-di-tert-butyl-4-hydroxyphenyl)propionate; an aromatic amine compound, such as N-phenyl-1,1,3,3-tetramethylbutylnaphthalene-1-amine, a reaction product of N-phenylbenzene and 2,4,4-trimethylpentene, and N-isopropyl-N′-phenyl-p-phenylenediamine; a phenol phosphite compound, such as triphenyl phosphite, tris(biphenyl-2-yl)phosphite, tris(biphenyl-4-yl)phosphite, tris(2-cyclohexylphenyl)phosphite, diphenyl phosphite, cyclic neopentanetetraylbis(2,6-di-tert-butyl-4-methylphenyl)phosphite, tris(2,5-di-tert-butyl-4-hydroxyphenyl)phosphite, tetrakis(O-(phenyltridecyl phosphite)methyl)methane, tris(4-nonylphenyl)phosphite, tris(2,4-di-tert-butylphenyl)phosphite, bis(nonylphenyl)(biphenyl-2-yl)phosphite, tris(α-methylbenzylphenyl)phosphite, bis(cyclohexylphenyl)phosphite, tetraalkyl-4,4′-butylidenebis(2-tert-butyl-5-methylphenyl)diphosphite, tris(2,4-di-tert-butylphenyl)phosphate(=Irgafos 168), tris(2,5-di-tert-butyl-4-hydroxyphenyl)phosphite, diphenyl(C₁₂₋₂₀)alkyl phosphite, tris(2,5-di-tert-butyl-4-hydroxyphenyl)phosphite, (di(C₈₋₁₈)alkylbis((C₈₋₁₈)alkylphenyl) or tetra(C₈₋₁₈)alkyl-4,4′-isopropylydenedicyclohexyl di phosphite, (C₈₋₁₂)alkyl (or (C₈₋₁₂)alkylphenyl)cyclohexylphenyl phosphite, di(or mono)isopropylbenzylmono(or di)phenyl phosphite, di(or mono)(isopropylbenzyl)mono(or di)phenyl phosphite, diphenyl(C₁₇₋₂₅) isoalkyl phosphite, hexaalkyl or (tri(C₈₋₁₈)alkyltris(C₈₋₉)alkylphenyl)-1,1,3-tris(3-tert-butyl-6-methyl-4-oxyphenyl)-3-methylpropane triphosphite, tetra(2-nonylphenyl)diisopropylene glycol diphosphite, tetra(3-nonylphenyl)diisopropylene glycol diphosphite, tetra(4-nonylphenyl)diisopropylene glycol diphosphite and di(lauryloxyethyl)phenyl phosphite; a compound having a carbodiimide group, such as N,N′-diisopropylhexylcarbodiimide(DCC), N,N′-diisopropylcarbodiimide and N-ethyl-N′-(3-dimethylaminoprolyl); a compound having an acyl group or an isocyanate group; and tocopherol.

One or plural kinds of compounds selected from the aforementioned compounds may be used as the hydrolysis inhibitor contained in the insulating liquid, and among these compounds, a phenol phosphite compound is preferably used as the hydrolysis inhibitor. In the case where the hydrolysis inhibitor is contained in the insulating liquid, a suitable amount of a free fatty acid can be contained in the insulating liquid while suppressing a free fatty acid from being generated from the fatty acid triglyceride and the fatty acid monoester. The liquid developer using the insulating liquid is improved in storage stability and long-term stability, and simultaneously, the toner particles can be further improved in fixing property to a recording medium. Furthermore, odor generated from the fatty acid triglyceride and the fatty acid monoester upon fixing can be further effectively prevented from occurring. It is considered that the advantages can be obtained based on the following mechanisms.

Upon storing the liquid developer, only a suitable amount of a free fatty acid is contained in the insulating liquid, and the free fatty acid does not provide adverse influence on the liquid developer to provide excellent storage stability and long-term stability of the liquid developer. Upon fixing, the free fatty acid permeates the toner particles along with the fatty acid monoester. The free fatty acid has a smaller molecular weight than the fatty acid monoester before decomposition and has larger permeability to the toner particles. Accordingly, the insulating liquid containing a suitable amount of the free fatty acid strongly exhibits the plasticizing effect of the toner particles, as compared to the insulating liquid containing no free fatty acid, and the toner particles can be quickly fixed to a recording medium. The liquid developer is thus suitable for image formation at high speed.

Upon fixing, furthermore, the liquid developer is applied with heat, and the function of suppressing hydrolysis of the phenol phosphite compound is reduced by the heat, whereby the fatty acid triglyceride and the fatty acid monoester are liable to be decomposed to a fatty acid (free fatty acid) and an alcohol. Accordingly, the free fatty acid generated in the insulating liquid upon fixing accelerates the plasticizing effect to the toner particles, whereby the toner particles can be firmly fixed to a recording medium. Moreover, the free fatty acid is rich in affinity and reactivity with the constitutional material of paper (i.e., cellulose) as the recording medium, and a part of the free fatty acid favorably permeates the paper, with another parts of the free fatty acid undergoing reaction with a hydroxyl group of cellulose to form an ester bond. The free fatty acid thus bonded with the ester bond is not vaporized, whereby the fixing property is improved, and the amounts of volatile components of the insulating liquid upon fixing can be reduced to suppress effectively odor generated from an image forming apparatus.

The phenol phosphite compound maintains the function of a hydrolysis inhibitor for a prolonged period of time, and in the case, for example, where the liquid developer is stored for a prolonged period of time, a free fatty acid can be suppressed from being generated excessively in the liquid developer. Accordingly, the toner particles can be firmly fixed to a recording medium, and the liquid developer can be particularly improved in storage stability and long-term stability.

The phenol phosphite compound is generally a transparent or light-white compound, and in the case where the compound is used in a toner, the compound has little affect on color tone of a toner image formed. The phenol phosphite compound is stable to heat, and may not be broken with heat for fixing upon forming an image. Accordingly, the phenol phosphite compound is not deteriorated after fixing, and may not have affect on color toner of a toner image after fixing.

The phenol phosphite compound preferably has a molecular weight of from 173 to 2,000, and more preferably from 200 to 1,500. In the case where the phenol phosphite compound has a molecular weight in the range, the phenol phosphite compound is excellent in affinity with the insulating liquid to provide excellent environmental stability of the liquid developer.

Among the aforementioned phenol phosphite compounds, tetraalkyl-4,4′-butylidenebis(2-tert-butyl-5-methylphenyl)diphosphite is preferably used, and tetramidecyl-4,4′-butylidenebis(2-tert-butyl-5-methylphenyl)diphosphite is more preferably used.

According to the constitution, the aforementioned advantages can be conspicuously exhibited.

The content of the hydrolysis inhibitor in the insulating liquid is preferably from 0.01 to 5.0% by weight, and more preferably from 0.05 to 2.0% by weight, based on the total amount of the insulating liquid. The insulating liquid satisfying the conditions can effectively suppress generation of a free fatty acid from the fatty acid triglyceride and the fatty acid monoester. Accordingly, the toner particles are improved in fixing property, and the liquid developer is improved in storage stability and long-term stability.

The liquid developer (insulating liquid) may contain a dispersant capable of improving dispersibility of the toner particles.

Examples of the dispersant include a polymer dispersant, such as polyvinyl alcohol, carboxymethyl cellulose, polyethylene glycol, Solsperse (a trade name, produced by Lubrizol Corp. Japan), a polycarboxylic acid and a salt thereof, a polyacrylic acid metallic salt (such as a sodium salt), a polymethacrylic acid metallic salt (such as sodium salt), a polymaleic acid metallic salt (such as sodium salt), an acrylic acid-maleic acid copolymer metallic salt (such as a sodium salt), a polystyrenesulfonic acid metallic salt (such as a sodium salt) and a polyamine-fatty acid polycondensate, a clay mineral, silica, calcium triphosphate, a tristearic acid metallic salt (such as an aluminum salt), a distearic acid metallic salt (such as an aluminum salt and a barium salt), a stearic acid metallic salt (such as a calcium salt, a lead salt and a zinc salt), a linolenic acid metallic salt (such as a cobalt salt, a manganese salt, a lead salt and a zinc salt), an octanoic acid metallic salt (such as an aluminum salt, a calcium salt and a cobalt salt), an oleic acid metallic salt (such as a calcium salt and a cobalt salt), a palmitic acid metallic salt (such as a zinc salt), a dodecylbenzenesulfonic acid metallic salt (such as a sodium salt), a naphthenic acid metallic salt (such as a calcium salt, a cobalt salt, a manganese salt, a lead salt and a zinc salt) and an abietic acid metallic salt (such as a calcium salt, a cobalt salt, a manganese salt, a lead salt and a zinc salt).

In the case where a polyamine-fatty acid polycondensate is used among the dispersants, the polyamine-fatty acid polycondensate can be firmly attached to the surface of the toner particles, whereby the toner particles can be prevented from suffering unintended aggregation. Furthermore, permeation property of the fatty acid monoester into the toner particles is improved, whereby the plasticizing effect of the fatty acid monoester can be conspicuously obtained. Consequently, the toner particles can be fixed to the recording medium further firmly. The toner particles are also improved in charging property.

In the case where a polyamine-fatty acid polycondensate is used, the content of the polyamine-fatty acid polycondensate in the liquid developer is preferably from 0.5 to 7.5 parts by weight, and more preferably from 1 to 5 parts by weight, per 100 parts by weight of the toner particles. According to the constitution, the advantages obtained by using the polyamine-fatty acid polycondensate can be exhibited further conspicuously.

The liquid developer (insulating liquid) may contain a charge controlling agent.

Examples of the charge controlling agent include a metallic oxide, such as zinc oxide, aluminum oxide and magnesium oxide, a metallic salt of benzoic acid, a metallic salt of salicylic acid, a metallic salt of an alkylsalicylic acid, a metallic salt of catechol, a metal-containing bisazo dye, a nigrosine dye, a tetraphenylborate derivative, a quaternary ammonium salt, an alkylpyridinium salt, chlorinated polyester and nitrohumic acid.

The insulating liquid preferably has an electric resistance at room temperature (20° C.) of 1.0×10¹² Ω·cm or more, more preferably 7×10¹² Ω·cm or more.

The insulating liquid preferably has a dielectric constant of 3.5 or less.

### Toner Particles

The toner particles will be described.

### Constitutional Material of Toner Particles (Toner Material)

The liquid developer according to an aspect of the invention contains toner particles dispersed in the liquid developer having the aforementioned constitution.

The toner particles (toner) constituting the liquid developer contain at least a resin material.

### 1. Resin Material

The toner constituting the liquid developer is constituted by a material containing a resin material as the major component.

The resin (binder resin) is not particularly limited in the invention, and for example, a known resin can be used, with the use of a polyester resin being preferred. A polyester resin has an ester component in the molecular structure, as similar to the fatty acid monoester and the fatty acid triglyceride described above, and thus has high affinity with the insulating liquid to provide particularly high dispersibility of the toner particles in the liquid developer. Upon fixing, permeation of the fatty acid monoester therein is facilitated to exhibit surely the plasticizing effect. Accordingly, the toner particles can be effectively prevented from suffering aggregation upon storing to improve the storage stability and the long-term stability of the liquid developer, and the toner particles are improved in fixing property to a recording medium. Furthermore, a polyester resin has high transparency, and provides, upon using as a binder resin, an image having good coloring property.

The resin preferably has an acid value of from 0.1 to 15 mgKOH/mg, more preferably from 1 to 10 mgKOH/mg, and further preferably from 3 to 8 mgKOH/mg. The toner particles constituted by the resin material satisfying the conditions are excellent in affinity with the insulating liquid. Accordingly, upon storing, the dispersibility of the toner particles in the liquid developer is improved, and the toner particles can be prevented further effectively from being aggregated with each other for a prolonged period of time. Upon fixing, furthermore, the insulating liquid favorably permeates the toner particles to exhibit the plasticizing effect strongly, whereby the toner particles can be firmly fixed to the recording medium.

The softening temperature of the resin (resin material) is not particularly limited and is preferably from 50 to 130° C., more preferably from 50 to 120° C., and further preferably from 60 to 115° C. The softening temperature referred herein means a softening starting temperature determined with a Koka-type flow tester (produced by Shimadzu Corp.) under measuring conditions of a temperature increasing rate of 5° C. per minute and a die hole diameter of 1.0 mm.

### 2. Colorant

The toner may contain a colorant. The colorant is not particularly limited, and for example, a pigment, a dye and the like having been known may be used.

### 3. Other Components

The toner may contain other components than those described above. Examples of the components include wax and magnetic powder having been known.

The material constituting the toner may contain other constitutional materials (components) than those described above, for example, zinc stearate, zinc oxide, cerium oxide, silica, titanium oxide, iron oxide, a fatty acid, a fatty acid metallic salt and the like may be used.

### Shape, etc. of Toner Particles

The toner particles used in the liquid developer of the invention preferably have minute unevenness on the surface thereof. By providing the minute unevenness, the fatty acid monoester can be effectively localized (adsorbed) in the vicinity of the surface of the toner particles.

The toner particles constituted by the aforementioned materials preferably have an average particle diameter of from 0.1 to 3 μm, more preferably from 0.5 to 2.5 μm, and further preferably from 0.5 to 2.0 μm. In the case where the average particle diameter of the toner particles is in the range, a resolution of an image formed with the liquid developer (toner) can be sufficiently increased. By using the insulating liquid according to an aspect of the invention, the particle diameter of the toner particles pulverized or crashed in the insulating liquid surely have a particle diameter within the range. The term “average particle diameter” referred herein means a volume average particle diameter.

The toner particles constituting the liquid developer preferably has a standard deviation of particle diameter of 1.0 μm or less, more preferably from 0.1 to 1.0 μm, and further preferably from 0.1 to 0.8 μm. According to the constitution, the respective toner particles suffer particularly small fluctuation in characteristics, whereby the liquid developer is improved in total reliability.

The toner particles constituting the liquid developer preferably has an average value of circularity R (average circularity) represented by the following expression (I) of from 0.94 to 0.99, and more preferably from 0.96 to 0.99.

R=L0/L1 (I)

wherein L1 (μm) represents the peripheral length of the projected image of the toner particle to be measured, and L0 (μm) represents the peripheral length of the true circle having the same area as the projected image of the toner particle to be measured.

In the case where the average circularity of the toner particles is in the range, the insulating liquid can be appropriately contained in an unfixed toner image transferred to a recording medium, whereby the fixing strength of the toner particles can be further improved.

The content of the toner particles in the liquid developer is preferably from 10 to 60% by weight, and more preferably from 20 to 50% by weight.

The viscosity (viscosity measured with a vibration viscometer at 25° C. according to JIS Z8809) of the liquid developer constituted by the aforementioned components (i.e., the liquid developer of the invention) is preferably from 50 to 1,000 mPa·s, more preferably from 10 to 900 mPa·s, and further preferably from 150 to 800 mPa·s. According to the constitution, the liquid developer appropriately permeates the recording medium, whereby the fixing property of the toner particles to the recording medium is improved. Furthermore, an image obtained on the recording medium becomes sharp without unevenness, and moreover, the liquid developer becomes suitable particularly for high-speed image formation. In the case where the fatty acid monoester is not contained, however, the viscosity of the insulating liquid becomes too high, and the toner particles having a large amount of the insulating liquid attached to the surface thereof are fixed to the recording medium. In the case where a large amount of the insulating liquid is attached to the surface of the toner particles, there is a possibility in that the fixing property of the toner particles to the recording medium is deteriorated due to difficulty in permeation of the insulating liquid into the recording medium, so as to make high-speed image formation difficult. Furthermore, the plasticizing effect cannot be sufficiently exhibited to fail to obtain improvement in fixing property and glossiness of an image formed. In the case where the fatty acid triglyceride is not contained, the viscosity of the insulating liquid becomes too low. Accordingly, in an image forming apparatus described later, for example, it becomes difficult to pick up the liquid developer with a coating roller from a developer container, whereby the toner particles may not be fixed uniformly to the recording medium. Consequently, there is a possibility in that the resulting image suffers unevenness with a low image density, and the fixing property of the toner particles to the recording medium becomes insufficient.

The electric resistance of the liquid developer constituted by the aforementioned components (i.e., the liquid developer of the invention) is preferably 1.5×10¹² Ω·cm or more, and more preferably 2.0×10¹² Ω·cm or more.

The insulating liquid can be produced, for example, by mixing the fatty acid triglyceride and the fatty acid monoester. The liquid developer can be produced by mixing the insulating liquid and the toner particles, and in alternative, can be produced by the following manners.

### Production Process of Liquid Developer

Preferred embodiments of the production process of the liquid developer according to an aspect of the invention will be described.

### First Embodiment

A first embodiment of the production process of the liquid developer according to an aspect of the invention will be described.

The production process of the liquid developer of the embodiment contains a toner material preparing step of preparing a toner material containing a resin material and a colorant, a pulverizing step of pulverizing a coarsely pulverized product constituted by the toner material in the fatty acid monoester or a mixed solution of the fatty acid monoester and a part of the fatty acid triglyceride to obtain a pulverized product dispersion liquid, and a mixing step of mixing the pulverized product dispersion liquid and the fatty acid triglyceride.

### Preparation of Toner Material

An example of the preparing method of a toner material constituted mainly by a resin material.

The toner material may be prepared by any method. In the embodiment, the toner material including a resin material, a colorant and the like having been known in the field of art are kneaded to provide a kneaded product constituted by the toner material, and then the kneaded material is coarsely pulverized to provide a coarsely pulverized product constituted by the toner material.

The resin material and the colorant are kneaded, whereby even in the case where the materials constituting the toner particles contain components that are difficult to be dispersed or dissolved with each other in the pulverizing step described later, the components can be sufficiently dissolved or finely dispersed with each other in the resulting kneaded product. Consequently, the respective toner particles suffer particularly small fluctuation in characteristics. Furthermore, the kneaded product constituted by the toner material is coarsely pulverized before the pulverizing step described later, whereby the particle diameter of the toner particles can be effectively reduced in the pulverizing step.

### Pulverization

The constitutional material (toner material) of the toner particles is pulverized in a wet state in the fatty acid monoester having the aforementioned characteristics, or a mixed solution of the fatty acid monoester having the aforementioned characteristics and a part of the fatty acid triglyceride (which may be referred to as a fatty acid ester liquid for pulverization), so as to provide a pulverized product dispersion liquid.

The fatty acid ester liquid for pulverization has a relatively low viscosity and provides a high degree of freedom in movement of the toner material in the liquid, whereby the coarsely pulverized product can be pulverized efficiently. The fatty acid ester liquid for pulverization has high affinity with the known resin material having been described above, and has a relatively low viscosity, whereby the fatty acid ester liquid for pulverization can penetrate into minute cracks of the toner material formed by pulverization or the like. Consequently, the toner material can be pulverized efficiently to provide toner particles having a sufficiently small particle diameter efficiently. The pulverization rate can also be improved. The toner material is pulverized in the fatty acid ester liquid for pulverization having a relatively low viscosity, whereby the energy applied for pulverizing can be efficiently used for pulverization of the toner material, and thus the temperature of the fatty acid ester liquid for pulverization can be prevented from being increased. As a result, the toner material can be pulverized efficiently even in the case where the resin material constituting the toner material has a low melting point.

The toner material is pulverized in the fatty acid ester liquid for pulverization, whereby in the liquid developer finally obtained, the fatty acid monoester contained in the fatty acid ester liquid for pulverization can be localized (adsorbed) to the vicinity of the surface of the toner particles. The fatty acid monoester is thus localized to the vicinity of the surface of the toner particles in this manner, whereby the plasticizing effect can be exhibited conspicuously. As a result, the toner particles are liable to penetrate into the paper fibers (recording medium) to improve particularly the fixing strength of the toner particles.

The method of wet-pulverization is not particularly limited, and for example, the wet-pulverization operation can be carried out by using various kinds of pulverizing equipments and crashing equipments, such as a ball mill, a vibration mill, a jet mill and pin mill.

The step of wet-pulverization may be carried out by dividing into plural times.

The dispersant having been described above may be added to the fatty acid ester liquid for pulverization before mixing the fatty acid ester liquid for pulverization and the toner material. According to the operation, the dispersant functions as a pulverization assistant, whereby the toner material can be pulverized efficiently, and the resulting toner particles are improved in dispersibility.

The toner material is thus pulverized in the state where the fatty acid ester liquid for pulverization contains the dispersant, whereby the dispersant is liable to be attached to the surface of the toner particles, and the liquid developer finally obtained is improved in charging property.

In the case where a polyamine-fatty acid polycondensate among the aforementioned dispersants is used, the pulverization efficiency can be effectively improved. In the case where the toner material is pulverized in the fatty acid ester liquid for pulverization in the presence of the polyamine-fatty acid polycondensate, the polyamine-fatty acid polycondensate can be made present on the surface of the toner particles favorably (in an entangled manner), and thus the fatty acid monoester can be effectively retained in the vicinity of the surface of the toner particles upon mixing with the fatty acid triglyceride later. Consequently, the toner particles in the liquid developer finally obtained can be further improved in dispersibility, and the fixing property thereof can also be improved.

### Mixing

The resulting pulverized product dispersion liquid and the fatty acid triglyceride are mixed (mixing step).

The liquid developer according to an aspect of the invention is obtained, in which the toner particles are dispersed in the insulating liquid containing the fatty acid triglyceride and the fatty acid monoester.

### Second Embodiment

A second embodiment of the production process of the liquid developer according to an aspect of the invention will be described.

The production method of the liquid developer of the invention according to the embodiment contains steps of: aggregating resin fine particles constituted mainly by a resin material to form aggregated particles; pulverizing the aggregated particles in the fatty acid monoester or a mixed liquid of the fatty acid monoester and a part of the fatty acid triglyceride (which may be referred to as a fatty acid ester liquid for pulverization) to form a toner particle dispersion liquid having toner particles dispersed in the fatty acid ester liquid for pulverization; and mixing the resulting toner particle dispersion liquid with the fatty acid triglyceride.

### Preparation of Aggregated Particles

An example of a preparation method of the aggregated particles obtained by aggregating resin fine particles constituted mainly by a resin material will be described.

The aggregated particles may be prepared by any method, and in this embodiment, the aggregated particles are obtained in such a manner that an aqueous dispersion liquid containing a dispersoid (fine particles) constituted mainly by a resin material (toner material) dispersed in an aqueous dispersion medium constituted by an aqueous liquid is obtained, and the dispersoid in the aqueous dispersion liquid is aggregated to provide aggregated particles.

### Preparation of Aqueous Dispersion Liquid

Preparation of the Aqueous Dispersion Liquid will be described.

The aqueous dispersion liquid may be prepared by any method, and in this embodiment, the aqueous dispersion liquid is obtained in the following manner. The toner material is dissolved in a solvent to provide a toner material solution, and the toner material solution and an aqueous dispersion medium constituted by an aqueous liquid are mixed to provide an aqueous emulsion having a dispersoid (liquid dispersoid) containing the toner material dispersed therein. Thereafter, at least a part of the solvent contained in the aqueous emulsion is removed to provide an aqueous dispersion liquid.

The aqueous emulsion can be prepared, for example, by the following manner (preparation of the aqueous emulsion).

An aqueous dispersion medium is prepared.

The aqueous dispersion medium is constituted by an aqueous liquid.

The aqueous liquid referred herein means a liquid constituted by water and/or a liquid excellent in compatibility with water (for example, a liquid having a solubility of 30 g or more in 100 g of water at 25° C.). The aqueous liquid is constituted by water and/or a liquid excellent in compatibility with water, and is preferably constituted mainly by water. The content of water is preferably 70% by weight or more, and more preferably 90% by weight or more. By using the aqueous liquid, the dispersibility of the dispersoid in the aqueous dispersion medium can be improved, whereby the dispersoid in the aqueous emulsion has a relatively small particle diameter with less fluctuation in size. As a result, the toner particles in the liquid developer finally obtained have small fluctuation in size and shape among the particles and have a high circularity.

Specific examples of the aqueous liquid include water, an alcohol solvent, such as methanol, ethanol and propanol, an ether solvent, such as 1,4-dioxane and tetrahydrofuran (THF), an aromatic heterocyclic solvent, such as pyridine, pyrazine and pyrrole, an amide solvent, such as N,N-dimethylformamide (DMF) and N,N-dimethylacetamide (DMA), a nitrile solvent, such as acetonitrile, and an aldehyde solvent, such as acetoaldehyde.

An emulsification dispersant may be added to the aqueous dispersion medium depending on necessity. The aqueous emulsion can be prepared easily by adding an emulsification dispersant.

The emulsification dispersant is not particularly limited, and known emulsification dispersants may be used.

The toner material is dissolved in a solvent to prepare a toner material solution.

The solvent is not limited as far as it dissolves at least a part of the toner material, and a solvent having a boiling point that is lower than that of the aqueous liquid is preferably used. According to the constitution, the solvent can be easily removed.

The solvent preferably has low compatibility with the aqueous dispersion medium (aqueous liquid) (for example, a liquid having a solubility of 30 g or less in 100 g of water at 25° C.). According to the constitution, the toner material can be finely dispersed in the aqueous emulsion in a stable manner.

The composition of the solvent may be appropriately selected depending, for example, on the compositions of the known resin and the colorant and the composition of the aqueous dispersion medium.

The solvent is not particularly limited, and examples thereof include a ketone solvent, such as MEK, and an aromatic hydrocarbon solvent, such as toluene.

A kneaded product obtained by kneading the materials for the toner, such as the resin material and the colorant, may be used for preparing the toner material solution. By using the kneaded product, the materials for constituting the toner can be in a sufficiently mixed and finely dispersed state by kneading even though the materials include such components that are less compatible with each other. In the case where a pigment (colorant) that has relatively poor compatibility to the solvent is used, particularly, the periphery of the pigment particles is effectively coated with the resin component and the like by preliminarily kneading before dispersing in the solvent, whereby the dispersibility of the pigment in the solvent is improved (i.e., the pigment can be finely dispersed in the solvent), and the coloring property of the toner finally obtained is also improved. Accordingly, even in the case where a component that is poor in dispersibility in the aqueous dispersion medium of the aqueous emulsion or a component that is poor in solubility in the solvent contained in the dispersion medium of the aqueous emulsion is contained, the dispersibility of the dispersoid in the aqueous emulsion can be particularly improved.

Subsequently, the toner material solution is gradually added dropwise to the aqueous dispersion medium under stirring, whereby the aqueous emulsion having the dispersoid containing the toner material dispersed therein can be obtained. Upon adding the toner material solution dropwise, the aqueous dispersion medium and/or the toner material solution may be heated.

Thereafter, the resulting aqueous emulsion is heated or allowed to stand under a reduced pressure for removing at least a part of the solvent contained in the dispersoid, whereby the aqueous dispersion liquid having the dispersoid (fine particles) constituted by the toner material dispersed therein is obtained.

The content of the dispersoid in the aqueous dispersion liquid is not particularly limited and is preferably from 5 to 55% by weight, and more preferably from 10 to 50% by weight. According to the constitution, the productivity of the toner particles (liquid developer) can be particularly improved while the dispersoid is effectively prevented from suffering unintended aggregation in the aqueous dispersion liquid.

The average particle diameter of the dispersoid in the aqueous dispersion liquid is not particularly limited and is preferably from 0.01 to 3 μm, and more preferably from 0.1 to 2 μm. According to the constitution, the size of the toner particles finally obtained can be optimized. The term “average particle diameter” referred herein means a volume average particle diameter.

### Formation of Aggregated Particles

An electrolyte is added to the aqueous dispersion liquid thus obtained, whereby the dispersoid is aggregated to provide aggregated particles (formation of aggregated particles).

Examples of the electrolyte to be added include an acidic substance, such as hydrochloric acid, sulfuric acid, phosphoric acid, acetic acid and oxalic acid, and an organic or inorganic water-soluble salt, such as sodium sulfate, ammonium sulfate, potassium sulfate, magnesium sulfate, sodium phosphate, sodium dihydrogenphosphate, sodium chloride, potassium chloride, ammonium chloride, calcium chloride and sodium acetate, and these substances may be used solely or in combination of plural kinds of them. Among these, a sulfate of a monovalent cation, such as sodium sulfate and ammonium sulfate, is preferably used for attaining uniform aggregation.

Before adding the electrolyte and the like, an inorganic dispersion stabilizer, such as hydroxyapatite, and an ionic or nonionic surfactant may be added. In the case where the electrolyte is added in the presence of the dispersion stabilizer (emulsifier), uneven aggregation can be prevented from occurring.

Examples of the dispersion stabilizer include a nonionic surfactant, such as polyoxyethylene nonylphenyl ether, polyoxyethylene octylphenyl ether, polyoxyethylene decylphenyl ether, polyoxyethylene alkyl ether, polyoxyethylene fatty acid ester, sorbitan fatty acid ester, polyoxyethylene sorbitan fatty acid ester and various kinds of Pluronic series surfactant, an anionic surfactant of alkyl sulfuric ester salt type, and a cationic surfactant, such as a quaternary ammonium salt surfactant. Among these, an anionic or nonionic surfactant is preferred since it is effective for improving dispersion stability with only a small addition amount. The nonionic surfactant preferably has a clouding point of 40° C. or more.

The amount of the electrolyte added is preferably from 0.5 to 15 parts by weight, more preferably from 1 to 12 parts by weight, and further preferably from 1 to 10 parts by weight, per 100 parts by weight of the solid content in the aqueous dispersion liquid. In the case where the addition amount of the electrolyte is less than the lower limit, there are some cases where aggregation of the dispersoid cannot sufficiently proceed. In the case where the addition amount of the electrolyte exceeds the upper limit, there is a possibility in that aggregation of the dispersoid proceeds unevenly to form coarse particles, whereby the toner particles finally obtained suffer fluctuation in size.

After the aggregation operation, aggregated particles are obtained by carrying out such operations as filtering, washing and drying.

The average particle diameter of the resulting aggregated particles is preferably from 0.1 to 7 μm, and more preferably from 0.5 to 3 μm. According to the constitution, the toner particles finally obtained can have an appropriate particle diameter.

### Pulverization

The aggregated particles thus obtained are pulverized in the fatty acid ester liquid for pulverization (pulverization). According to the operation, a toner particle dispersion liquid having the toner particles dispersed in the fatty acid ester liquid for pulverization is obtained. The fatty acid ester liquid for pulverization contains the fatty acid monoester having the aforementioned characteristics. Accordingly, the aggregated particles can be favorably pulverized to provide the toner particles having a sufficiently small particle diameter.

The aggregated particles are pulverized in the fatty acid ester liquid for pulverization, whereby the fatty acid monoester contained in the fatty acid ester liquid for pulverization can be localized (adsorbed) to the vicinity of the surface of the toner particles in the liquid developer finally obtained. The fatty acid monoester is localized to the vicinity of the surface of the toner particles, whereby the plasticizing effect can be conspicuously exhibited. As a result, penetration of the toner particles into the paper fibers (recording medium) is facilitated to improve particularly the fixing strength of the toner particles.

Furthermore, since the aggregated particles are pulverized in the fatty acid ester liquid for pulverization, which is in a liquid state, coarse toner particles due to aggregation can be prevented from being formed.

The resulting toner particles have unevenness derived from the fine particles (dispersoid) on the surface thereof, whereby the fatty acid mono ester can be surely retained by the unevenness.

In this embodiment, the toner particles are obtained by pulverizing the aggregated particles, whereby fine powder (particles having an excessively smaller size than the intended particles) can be effectively prevented from being formed as compared to the pulverizing method and the wet pulverizing method, which have been practiced. Consequently, the charging property of the liquid developer can be effectively prevented from being deteriorated.

The fatty acid ester liquid for pulverization has a low viscosity and thus easily permeates among the fine particles (dispersoid) to pulverize the aggregated particles favorably.

### Mixing

The toner particle dispersion liquid thus obtained and the fatty acid triglyceride are mixed to disperse the toner particles in the insulating liquid (mixing).

According to the aforementioned operations, the liquid developer according to an aspect of the invention is obtained, which contains the toner particles dispersed in the insulating liquid containing the fatty acid triglyceride and the fatty acid monoester.

### Image Forming Apparatus

Preferred embodiments of the image forming apparatus according to an aspect of the invention will be described.

### First Embodiment

A first embodiment of the image forming apparatus, to which the liquid developer according to an aspect of the invention is applied, will be described.

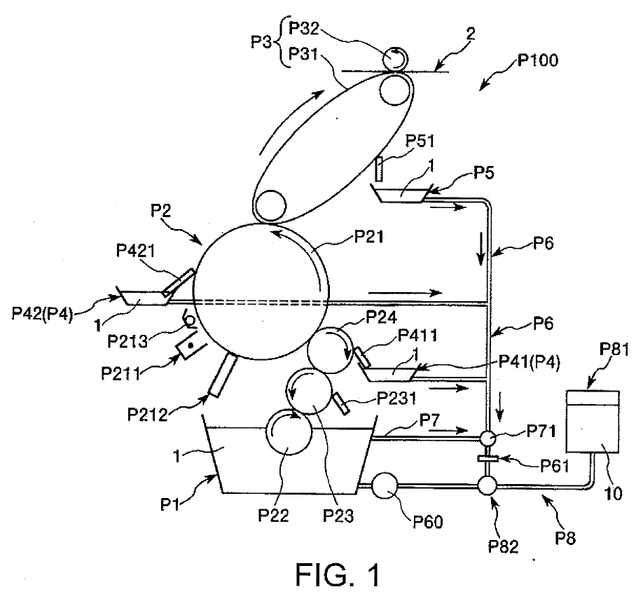

FIG. 1 is a cross sectional view showing an example of the first embodiment of the contact type image forming apparatus, to which a liquid developer according to an aspect of the invention is applied.

An image forming apparatus P100 has, as shown in FIG. 1, a liquid developer storing part P1 that stores a liquid developer 1; a developing part P2 that forms an image (toner image) by using the liquid developer 1 stored in the liquid developer storing part P1; a transferring part P3 that transfers the image formed in the developing part P2, onto a recording medium 2; a liquid developer recovering part P4 for developing part that recovers the liquid developer 1 becoming redundant in the developing part P2; a liquid developer recovering part P5 for transferring part that recovers the liquid developer 1 becoming redundant in the transferring part P3; a recovered liquid developer transporting part (transporting part) P6 that transports the liquid developer 1 having been recovered in the liquid developer recovering part P4 for developing part and the liquid developer recovering part P5 for transferring part, to the liquid developer storing part P1; a circulating part P7 that circulates the liquid developer 1 in the liquid developer storing part P1; and an insulating liquid replenishing part P8 that replenishes an insulating liquid replenisher 10 to the liquid developer 1 stored in the liquid developer storing part P1.

The liquid developer storing part P1 has a function of storing a liquid developer 1 having toner particles dispersed in an insulating liquid 10.

The developing part P2 has a photoreceptor P21 that forms an image, a liquid feeding roller P22 partially immersed in the liquid developer 1 in the liquid developer storing part P1, a liquid thickness regulating roller P23 that regulates the amount of the fed liquid developer; and a developing roller P24 that feeds the liquid developer to the photoreceptor P21.

The photoreceptor P21 is preferably has a photosensitive layer constituted by such a material as amorphous silicon. Amorphous silicon has a considerably high hardness and is excellent in wear resistance, as compared to an organic photosensitive material (OPC) having been used in the art. Accordingly, the surface of the photoreceptor P21 can be prevented from being damaged due to contact between the surface of the photoreceptor P21 and the toner particles. Furthermore, deterioration of the members due to the insulating liquid contained in the liquid developer can also be minimized. The photoreceptor P21 having these characteristics has a prolonged service life and is suitable for use for a prolonged period of time. Moreover, it is excellent in repetition stability in electric property and environmental stability (with respect to the temperature and humidity of the use environment), and thus the development accuracy to a recording medium can be maintained at a high level for a prolonged period of time.

The photoreceptor P21 is uniformly charged on the surface thereof with a charging device P211 constituted by epichlorohydrin rubber or the like, and then exposed corresponding to information to be recorded, with a line head exposing part P212 constituted by an organic EL device or the like, so as to provide an electrostatic latent image. After transferring a toner image from the photoreceptor P21 to an intermediate transfer belt P31 described later, the photoreceptor P21 is destaticized with destaticizing light P213.

The line head exposing part P212 will be described with reference to the drawing.

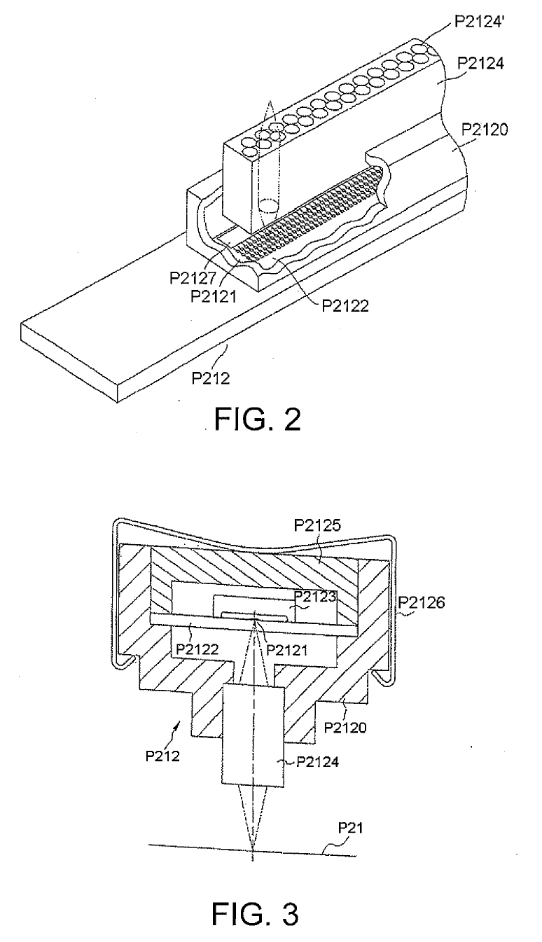

FIG. 2 is a schematic perspective view showing an example of the line head exposing part P212.

The line head exposing part P212 has a glass substrate P2122 having placed thereon a light emitting device array P2121 constituted by organic EL devices, which are driven with thin film transistors (TFT) P2127 formed on the glass substrate P2122. A gradient index rod lens array P2124 constitutes an imaging optical system, and is constituted by gradient index rod lenses P2124′ stacked in trefoil formation on the front side of the light emitting surface. A housing P2120 covers the periphery of the glass substrate P2122 with an opening on the side facing the photoreceptor P21. According to the constitution, light is emitted from the gradient index rod lenses P2124′ toward the photoreceptor P21. A light absorbing member (coating composition) is provided on the surface of the housing P2120 that faces the end surface of the glass substrate P2122.

FIG. 3 is a cross sectional view in the subscanning direction showing the line head exposing part P212. The line head exposing part P212 has the light emitting device array P2121 constituted by organic EL devices attached to the back surface of the gradient index rod lens array P2124 in the housing P2120, a sealing member P2123 covering the light emitting device array P2121, and an opaque cover P2125 shielding the light emitting device array P2121 constituted by organic EL devices in the housing P2120 from the back surface of the housing P2120.

The cover P2125 is pressed onto the back surface of the housing P2120 with a fixed leaf spring P2126 to seal the interior of the housing P2120 light-tightly. In other words, the glass substrate P2122 is optically sealed with the fixed leaf spring P2126 and the housing P2120. According to the constitution, total reflection on the end surface of the glass substrate P2122 is prevented to absorb light efficiently. The plural fixed leaf springs P2126 are provided at plural positions in the longitudinal direction of the housing P2120, which are not shown in FIG. 3.

The housing P2120 constituted by an opaque member in FIG. 3 is formed of a material that absorbs light, such as a synthetic resin, e.g., black polystyrene, and aluminum having alumite treatment. A black coating composition is coated on the surface of the housing P2120 that faces the end surface in the thickness direction on both sides of the glass substrate P2122, i.e., the end surface in the thickness direction in the subscanning direction, so as to increase the light absorbing property. Accordingly, the use of the organic EL devices as light emitting devices facilitates production of light emitting devices on a glass substrate. Consequently, the light emitting device can be formed into an arbitrary shape to reduce the production cost. The use of the line head exposing part P212 in an image forming apparatus provides such an image forming apparatus that suffers less image deterioration even though the apparatus is used for a prolonged period of time.

The liquid feeding roller P22 has a function of feeding the liquid developer to the liquid thickness regulating roller P23 through rotation.

The liquid thickness regulating roller P23 has a liquid thickness regulating blade P231, and the thickness of the liquid developer on the surface of the liquid thickness regulating roller P23 is maintained constant with the liquid thickness regulating blade P231. The liquid developer is transferred from the liquid thickness regulating roller P23 to the developing roller P24.

The developing roller P24 has a function of transferring the liquid developer to an electrostatic latent image on the surface of the photoreceptor P21. The developing roller P24 is rotated at the same speed as the photoreceptor P21 to transfer the liquid developer to the electrostatic latent image on the surface of the photoreceptor P21.

The transferring part P3 has an intermediate transfer belt P31 and a secondary transfer roller P32.

The toner image formed on the photoreceptor P21 is transferred to the intermediate transfer belt P31, and then the secondary transfer roller P32 is electrified to transfer the image to a recording medium 2, such as paper, passing between the intermediate transfer belt P31 and the secondary transfer roller P32.

Thereafter, the toner image (transferred image) 2a transferred on the recording medium 2 is fixed with a fixing device F40 described later.

The liquid developer recovering part P4 for developing part is constituted by a liquid developer recovering part P41 on the developing roller and a liquid developer recovering part P42 on the photoreceptor.

The liquid developer recovering part P41 on the developing roller has a cleaning blade P411 and has a function of recovering the liquid developer 1 remaining on the developing roller P24 after transferring to the photoreceptor P21, with the cleaning blade P411.

The liquid developer recovering part P42 on the photoreceptor has a cleaning blade P421 and has a function of recovering the liquid developer 1 remaining on the photoreceptor P21 after transferring to the intermediate transfer belt P31, with the cleaning blade P421.

The liquid developer recovering part P5 for transferring part has a cleaning blade P51 and has a function of recovering the liquid developer 1 remaining on the intermediate transfer belt P31 after transferring to the recording medium 2, with the cleaning blade P51.

The recovered liquid developer transporting part P6 has, as shown in FIG. 1, a pump P60, and has a function of transporting the liquid developer 1 recovered by the liquid developer recovering part P4 for developing part (including the liquid developer recovering part P41 on the developing roller and the liquid developer recovering part P42 on the photoreceptor) and the liquid developer recovering part P5 for transferring part, to the liquid developer storing part P1.

The liquid developer 1 recovered by the liquid developer recovering part P4 for developing part and the liquid developer recovering part P5 for transferring part is exposed to heat generated in the image forming apparatus in an operating state. Accordingly, even in the case where a liquid developer having been used in the art is recovered and transported to the liquid developer storing part, only a liquid developer in a deteriorated state is transported, which provide a possibility of deteriorating the storage stability and the long-term stability of the liquid developer stored in the liquid developer storing part. On the other hand, the insulating liquid constituting the liquid developer 1 according to an aspect of the invention is suppressed in hydrolysis of the fatty acid triglyceride and the fatty acid monoester, and the toner particles in the liquid developer are favorably prevented from being aggregated, at a high temperature. Accordingly, the liquid developer 1 can be favorably used in an image forming apparatus equipped with the aforementioned recovering parts, whereby the liquid developer 1 in the liquid developer storing part P1 can be improved in storage stability and long-term stability, and the liquid developer can be used economically.

The recovered liquid developer transporting part P6 also has, as shown in FIG. 1, a filter (impurity removing unit) P61.

The filter P61 has a function of removing impurities (such as coarsened toner particles and broken fragments of a recording medium) contained in the liquid developer 1 transported. According to the constitution, the liquid developer is prevented from being deteriorated to obtain a toner image with high image quality.

The liquid developer storing part P1 is equipped with a circulating part P7 that circulates the liquid developer 1 in the liquid developer storing part P1.

The circulating part P7 joins with the recovered liquid developer transporting part P6, and the liquid developer 1 transported by the circulating part P7 is filtered with the filter (impurity removing unit) P61 to remove impurities (such as coarsened toner particles and broken fragments of a recording medium) accumulated in the liquid developer 1.

The insulating liquid replenishing part P8 has an insulating liquid replenisher storing part P81 that stores an insulating liquid replenisher 10, and a replenishing part P82, and has a function of replenishing the insulating liquid replenisher 10 stored in the insulating liquid replenisher storing part P81, to the liquid developer 1 stored in the liquid developer storing part P1, through the replenishing part P82.

In the embodiment, the insulating liquid contained in the liquid developer 1 is transferred to the recording medium 2 along with the toner particles in the transferring part P3. Accordingly, the insulating liquid and the toner particles in the liquid developer 1 stored in the liquid developer storing part P1 are consumed through image formation. There are cases at this time where the insulating liquid and the toner particles in the liquid developer 1 stored in the liquid developer storing part P1 are different from each other in consumed amount through image formation, which provide cases where the concentration of the toner particles in the liquid developer 1 is changed. In these cases, the insulating liquid replenisher 10 is replenished by the insulating liquid replenishing part P8 to maintain the concentration of the toner particles in the liquid developer 1 within a prescribed range. Furthermore, the fresh insulating liquid replenisher 10 is replenished to prevent the insulating liquid in the liquid developer 1 from being deteriorated for a prolonged period of time.

The insulating liquid replenisher 10 contains the fatty acid triglyceride and the fatty acid monoester and generally has the same formulation as the insulating liquid contained in the liquid developer 1. According to the constitution, the toner particles can be more effectively prevented from being aggregated in the liquid developer storing part P1 to maintain the quality of the liquid developer to a high level for a prolonged period of time.

The insulating liquid replenisher 10 may have a formulation that is different from that of the insulating liquid contained in the liquid developer.

The insulating liquid replenisher 10 may contain toner particles. According to the constitution, the insulating liquid replenisher 10 containing toner particles is replenished to the liquid developer 1 to facilitate maintenance of the amount of the toner particles in the liquid developer 1 within a prescribed range. The concentration of the toner particles in the insulating liquid replenisher 10 may be higher than, lower than or the same as the concentration of the toner particles in the liquid developer 1.

While not shown in the figures, the insulating liquid replenisher storing part P81 may be equipped with plural preliminary storing tanks that store the constitutional components of the insulating liquid replenisher 10. The constitutional components contained in the preliminary storing tanks may be different from or the same as each other in formulation. In the case where the constitutional components are different from each other in formulation, the plural constitutional components in the preliminary storing tanks are mixed in the insulating liquid replenisher storing part P81 to produce easily the insulating liquid replenisher 10 having an arbitrary formulation.

An embodiment of image formation using a liquid developer of single color has been described with reference to FIG. 1, and in the case where image formation is carried out with color toners of plural colors, images of plural colors may be formed with developing devices of plural colors to form a color image.

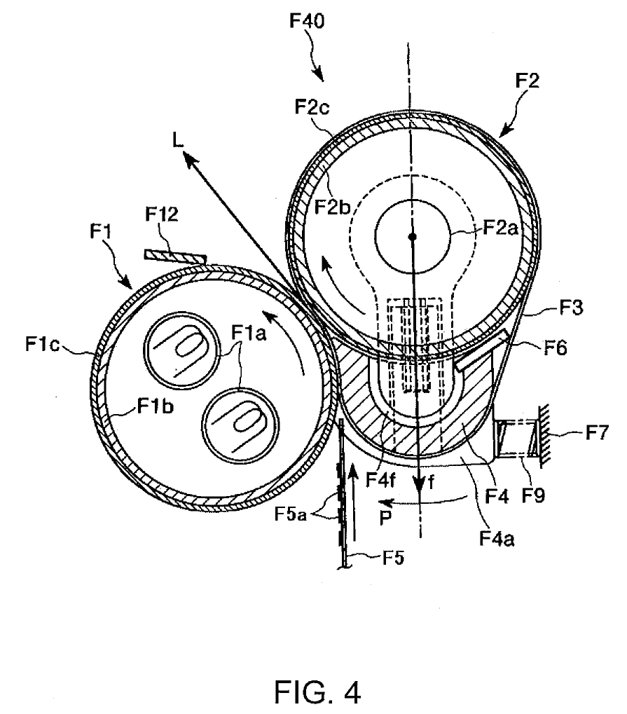

FIG. 4 is a cross sectional view showing an example of the fixing device.

The fixing device (fixing part) F40 fixes the unfixed toner image 2a formed in the developing part P2, the transferring part P3 and the like to the recording medium 2.

The fixing device F40 has, as shown in FIG. 4, a heat fixing roller F1, a pressure roller F2, a heat resistant belt F3, a belt stretching member F4, a cleaning member F6, a frame F7, an ultraviolet ray radiation unit F8 and a spring P9.

The heat fixing roller (fixing roller) F1 has a roller substrate F1b constituted by a tubular member, an elastic member F1c covering the outer periphery of the roller substrate F1b, and columnar halogen lamps F1a inside the roller substrate Fib, and is rotatable in the anticlockwise direction shown by the arrow in the figure.

The pressure roller F2 has a roller substrate F2b constituted by a tubular member, and an elastic member F2c covering the outer periphery of the roller substrate F2b, and is rotatable in the clockwise direction shown by the arrow in the figure.

A PFA layer is provided as a surface layer of the elastic member F1c of the heat fixing roller F1. According to the constitution, the elastic members F1c and F2c undergo elastic deformation in the substantially same manner to form a so-called horizontal nip although the elastic members F1c and F2c are different from each other in thickness, and no difference is formed in conveying speed between the peripheral speed of the heat fixing roller F1 and the speed of the heat resistant belt F3 or the recording medium F5 described later, whereby the image fixing operation can be carried out considerably stably.

Two columnar halogen lamps F1a and F1a constituting a heat source are installed inside the heat fixing roller F1, and heating elements of the columnar halogen lamps F1a and F1a are disposed at positions different from each other. The columnar halogen lamps F1a and F1a are selectively turned on, whereby the temperatures are controlled under different conditions including the fixing nip position where the heat resistant belt F3 described later is wound on the heat fixing roller F1 and the position where the belt stretching member F4 described later is in contact with the heat fixing roller F1, and under different conditions including a recording medium having a large width and a recording medium having a small width.

The pressure roller F2 is disposed to face the heat fixing roller F1 and applies pressure to the recording medium F5 having an unfixed toner image, through the heat resistant belt F3 described later. The insulating liquid can permeate efficiently the recording medium F5 by applying pressure. As a result, the unsaturated fatty acid component contained in the insulating liquid can be surely cured inside the recording medium F5 by heat or irradiation of an ultraviolet ray described later, whereby the toner image F5a can be further firmly fixed to the recording medium F5 through an anchoring effect.

The pressure roller F2 has a roller substrate F2b constituted by a tubular member and an elastic member F2c covering the outer periphery of the roller substrate F2b, and is rotatable in the clockwise direction shown by the arrow in the figure.

The elastic member F1c of the heat fixing roller F1 and the elastic member F2c of the pressure roller F2 undergo elastic deformation in the substantially same manner to form a so-called horizontal nip, and no difference is formed in conveying speed between the peripheral speed of the heat fixing roller F1 and the conveying speed of the heat resistant belt F3 or the recording medium F5 described later, whereby the image fixing operation can be carried out considerably stably.

The heat resistant belt F3 is an endless loop belt that is movably stretched on the outer peripheries of the pressure roller F2 and the stretching member F4 and held under pressure between the heat fixing roller F1 and the pressure roller F2.

The heat resistant belt F3 has a thickness of 0.03 mm or more and is formed of a seamless belt having a two-layer structure containing a front surface (i.e., the side in contact with the recording medium F5) formed of PFA and a back surface (i.e., the side in contact with the pressure roller F2 and the stretching member F4) formed of polyimide. The heat resistant belt F3 is not limited thereto and can be formed of other materials, such as a metallic tube, such as a stainless steel tube and a nickel electroformed tube, and a heat resistant resin tube, such as a silicone tube.

The belt stretching member F4 is disposed on the upstream side of the fixing nip part of the heat fixing roller F1 and the pressure roller F2 in the conveying direction of the recording medium F5 oscillatable in the direction shown by the arrow P with the rotation axis F2a of the pressure roller F2 as the center.

The belt stretching member F4 stretches the heat resistant belt F3 in the tangential direction of the heat fixing roller F1 under the state where the recording medium F5 does not pass through the fixing nip part. There are some cases where the recording medium F5 is not smoothly inserted to the fixing nip part and is wrinkled at the edge thereof upon fixing, in the case where the fixing pressure is too large at the initial position, at which the recording medium F5 is inserted to the fixing nip part. By stretching the heat resistant belt F3 in the tangential direction of the heat fixing roller F1, however, an introducing port, to which the recording medium F5 can be smoothly inserted, can be formed, whereby the recording medium F5 can be stably inserted to the fixing nip part.

The belt stretching member F4 is a belt sliding member having a substantially semilunar shape that is interfit inside the heat resistant belt F3 and applies a tension f to the heat resistant belt F3 associated with the pressure roller F2. The belt stretching member F4 is disposed at such a position that the nip part is formed by winding the heat resistant belt F3 thereon on the side of the heat fixing roller F1 with respect to the tangential direction L of the contact part under pressure of the heat fixing roller F1 and the pressure roller F2. A projected wall F4a is provided as being protruded from one end or both ends in the axial direction of the belt stretching member F4, and in the case where the heat resistant belt F3 is deviated toward one side in the axial direction, the deviation of the heat resistant belt F3 is regulated by making the heat resistant belt F3 in contact with the projected wall F4a. A spring F9 is provided in a compressed state between the side of the projected wall F4a opposite to the heat fixing roller F1 and the frame F7 to press lightly the projected wall F4a of the belt stretching member F4 onto the heat fixing roller F1, whereby the belt stretching member F4 is in contact under sliding with the heat fixing roller F1 for positioning.

The position where the belt stretching member F4 is lightly pressed onto the heat fixing roller F1 forms the nip start position, and the position where the pressure roller F2 is pressed onto the heat fixing roller F1 forms the nip end position.

In the fixing device F40, the recording medium F5 having an unfixed toner image F5a formed thereon is inserted to the fixing nip part from the nip start position, and then it passes between the heat resistant belt F3 and the heat fixing roller F1 and exits from the nip end position, whereby the unfixed toner image F5a formed on the recording medium is fixed under heat. Subsequently, the recording medium F5 is discharged in the tangential direction L of the contact part under pressure of the heat fixing roller F1 and the pressure roller F2.

An ultraviolet ray radiation unit F8 has a function of radiating an ultraviolet ray to the discharged recording medium F5 on the surface thereof having the toner image F5a formed. According to the constitution, the unsaturated fatty acid component contained in the insulating liquid can be firmly cured by heat and irradiation of an ultraviolet ray. As a result, the toner particles can be fixed to the recording medium further firmly. Owing to the irradiation of an ultraviolet ray, the toner particles can be firmly fixed to the recording medium without heating to a particularly high temperature with the heat fixing roller F1, whereby the toner particles can be fixed to the recording medium at a lower temperature and a higher speed, and the toner particles can be fixed to the recording medium further firmly, through the synergistic effect with the use of the liquid developer of the invention. Furthermore, since a large amount of heat energy is not needed for fixing, the toner particles can be sufficiently fixed to the recording medium by irradiation of an ultraviolet ray even when the period of time, for which the recording medium passes the fixing nip part, is relatively short. In other words, the fixing time can be shortened to increase the printing speed. Moreover, since a large amount of heat energy is not needed for fixing, energy saving can be enhanced. Consequently, an environmentally benign fixing device can be provided.

The cleaning member F6 is disposed between the pressure roller F2 and the belt stretching member F4.

The cleaning member F6 is in contact under sliding with the inner surface of the heat resistant belt F3 to clean foreign matters and abrasion powder on the inner surface of the heat resistant belt F3. The heat resistant belt F3 is refreshed by cleaning foreign matters and abrasion powder to reduce the destabilizing factor on friction coefficient described later. A concave portion F4f is provided on the belt stretching member F4 for housing the foreign matters and abrasion powder removed from the heat resistant belt F3.

For stably driving the heat resistant belt F3, which is stretched on the pressure roller F2 and the belt stretching member F4, with the pressure roller F2, the friction coefficient between the pressure roller F2 and the heat resistant belt F3 may be set larger than the friction coefficient between the belt stretching member F4 and the heat resistant belt F3. However, there are cases where the friction coefficient is destabilized due to insertion of foreign matters between the heat resistant belt F3 and the pressure roller F2 or the heat resistant belt F3 and the belt stretching member F4, or abrasion at the contact part of the heat resistant belt F3 with the pressure roller F2 or the belt stretching member F4.

Therefore, the winding angle of the heat resistant belt F3 on the pressure roller F2 is set smaller than the winding angle of the heat resistant belt F3 on the belt stretching member F4, and the diameter of the pressure roller F2 is set smaller than the diameter of the belt stretching member F4. According to the constitution, the length where the heat resistant belt F3 is in contact under sliding on the belt stretching member F4 to avoid the destabilizing factors due to time-lapse deterioration and external disturbance, whereby the heat resistant belt F3 can be stably driven with the pressure roller F2.

The time required for the toner particles passing through the fixing nip part (nip time) is preferably from 0.02 to 0.2 second, and more preferably from 0.03 to 0.1 second. Even with the short period of time required for the toner particles passing through the fixing nip part, the toner particles can be sufficiently fixed owing the use of the liquid developer of the invention, whereby the printing speed can be further improved.

The heat applied by the heat fixing roller F1 (fixing temperature) is preferably from 80 to 200° C., and more preferably from 100 to 180° C. In the case where the fixing temperature is in the range, the oxidation polymerization reaction (curing reaction) of the unsaturated fatty acid component contained in the insulating liquid can proceed further effectively.

### Second Embodiment

A second embodiment of the image forming apparatus, to which the liquid developer according to an aspect of the invention is applied, will be described.

An image forming apparatus according to the embodiment forms a color image on a recording medium by using a liquid developer according to an aspect of the invention having been described above.

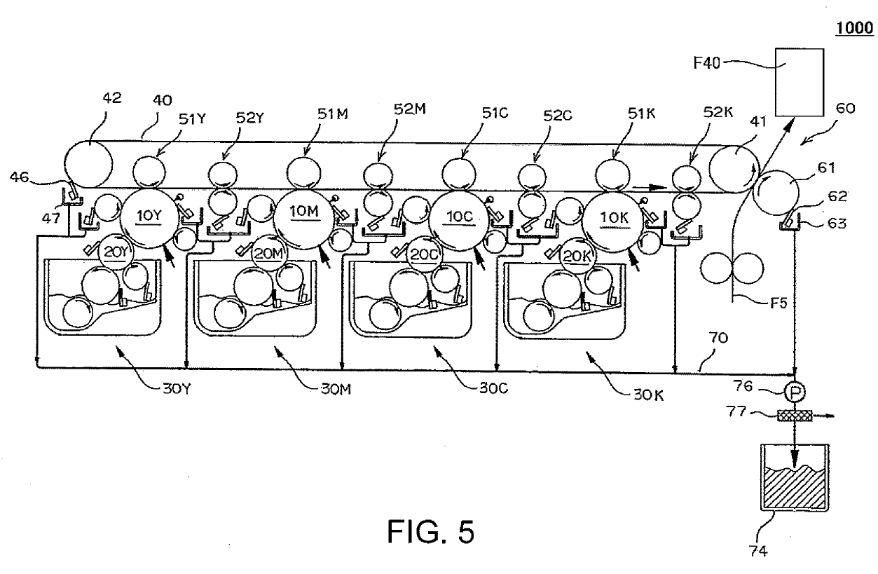

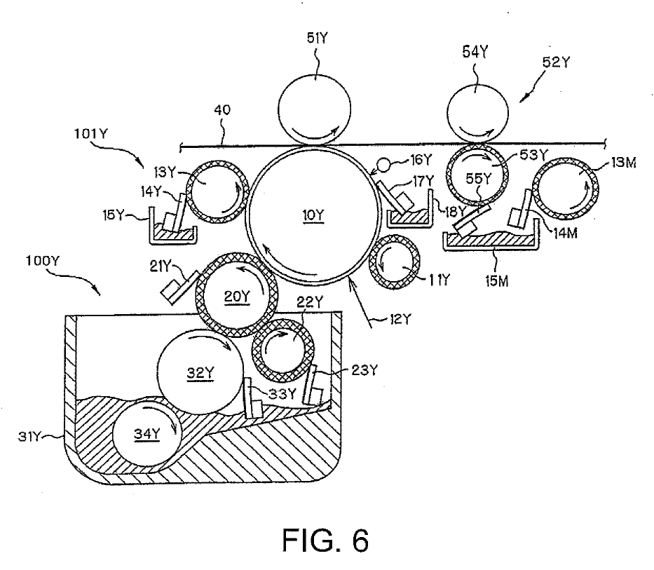

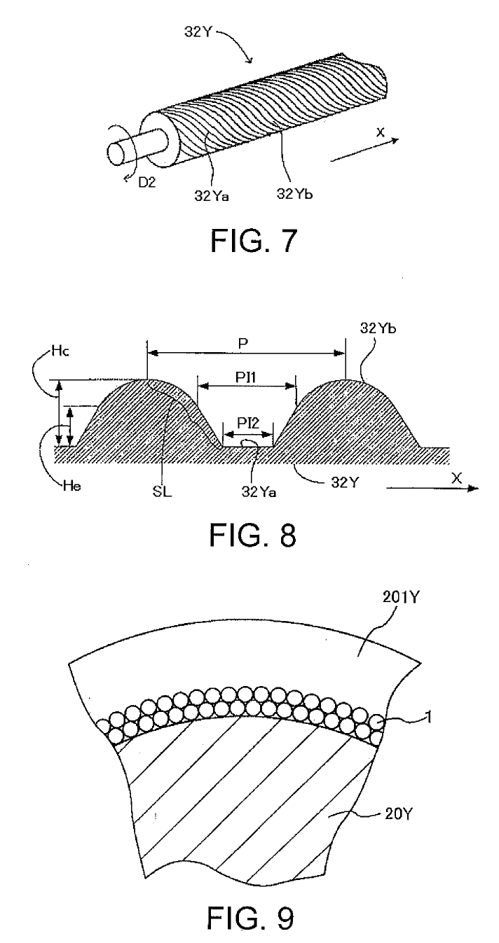

FIG. 5 is a schematic illustration showing an example of a second embodiment of an image forming apparatus, to which a liquid developer according to an aspect of the invention is applied. FIG. 6 is an enlarged illustration of a part of the image forming apparatus shown in FIG. 5. FIG. 7 is a perspective conceptual illustration showing a coating roller installed in the image forming apparatus shown in FIG. 5. FIG. 8 is an enlarged schematic illustration of the coating roller shown in FIG. 7. FIG. 9 is a schematic diagram showing the state of the toner particles in the liquid developer layer on the developing roller.

An image forming apparatus 1000 has, as shown in FIG. 5, four developing parts 30Y, 30M, 30C and 30K, an intermediate transferring part 40, a secondary transferring unit (secondary transferring part) 60 and a fixing part (fixing device) F40 that is the same as in the first embodiment.

The developing parts 30Y, 30M and 30C have a function of developing latent images with a yellow liquid developer (Y), a magenta liquid developer (M) and a cyan liquid developer (C) to form monochrome images corresponding to the colors, respectively. The developing part 30K has a function of developing a latent image with a black liquid developer (K) to form a black (K) monochrome image.

The developing parts 30Y, 30M, 30C and 30K have the same constitutions, and therefore, the developing part 30Y is described below.

The developing part 30Y has, as shown in FIG. 6, a photoreceptor 10Y as an example of an image carrying member, and has, along the rotation direction of the photoreceptor 10Y, a charging roller 11Y, an exposing unit 12Y, a developing unit 100Y, a photoreceptor squeezing device 101Y, a primary transfer backup roller 51Y, a destaticizing unit 16Y, a photoreceptor cleaning blade 17Y and a developer recovering part 18Y.

The photoreceptor 10Y has a tubular substrate having on an outer peripheral surface thereof a photoreceptor layer, and is rotatable with the center axis thereof as the center. In this embodiment, the photoreceptor 10Y is rotatable clockwise as shown by the arrow in FIG. 5.

The photoreceptor 10Y is preferably has a photosensitive layer constituted by such a material as amorphous silicon. Amorphous silicon has a considerably high hardness and is excellent in wear resistance, as compared to an organic photosensitive material (OPC) having been used in the art. Accordingly, the surface of the photoreceptor 10Y can be prevented from being damaged due to contact between the surface of the photoreceptor 10Y and the toner particles. Furthermore, deterioration of the members due to the insulating liquid contained in the liquid developer can also be minimized. The photoreceptor 10Y having these characteristics has a prolonged service life and is suitable for use for a prolonged period of time. Moreover, it is excellent in repetition stability in electric property and environmental stability (with respect to the temperature and humidity of the use environment), and thus the development accuracy to a recording medium can be maintained at a high level for a prolonged period of time.

A liquid developer is fed to the photoreceptor 10Y from the developing unit 100Y described later, and a layer of the liquid developer is formed on the surface thereof.

The charging roller 11Y is a device for charging the photoreceptor 10Y, and the exposing unit 12Y is a device for forming a latent image on the charged photoreceptor 10Y by radiating laser light. The exposing unit 12Y has a semiconductor laser, a polygonal mirror, an F-θ lens and the like, and radiates the photoreceptor 10Y with laser light modulated based on image signals input from a host computer, such as a personal computer and a word processor, which is not shown in the figure.

The developing unit 100Y is a device for developing the latent image formed on the photoreceptor 10Y with the liquid developer according to an aspect of the invention. The developing unit 100Y will be described in detail later.

The photoreceptor squeezing device 101Y is disposed to face the photoreceptor 10Y on the downstream side in the rotation direction with respect to the developing unit 100Y, and is constituted by a photoreceptor squeezing roller 13Y, a cleaning blade 14Y pressed onto the photoreceptor squeezing roller 13Y for removing the liquid developer attached to the surface of the photoreceptor squeezing roller 13Y, and a developer recovering part 15Y recovering the liquid developer thus removed with the cleaning blade 14Y. The photoreceptor squeezing device 101Y has a function of recovering an excessive carrier (insulating liquid) and an unnecessary fogging toner from the developer having been developed on the photoreceptor 10Y to improve the proportion of the toner particles in the developed image.

A primary transfer backup roller 51Y is a device for transferring the monochrome image formed on the photoreceptor 10Y to the intermediate transferring part 40 described later.

The destaticizing unit 16Y is a device for removing remaining charge on the photoreceptor 10Y after transferring the intermediate transfer image to the intermediate transferring part 40 described later with the primary transfer backup roller 51Y.

The photoreceptor cleaning blade 17Y is a rubber member pressed onto the surface of the photoreceptor 10Y and has a function of scraping and removing the liquid developer remaining on the photoreceptor 10Y after transferring the image to the intermediate transferring part 40 described later with the primary transfer backup roller 51Y.

The developer recovering part 18Y has a function of recovering the liquid developer thus removed with the photoreceptor cleaning blade 17Y.

The intermediate transferring part 40 is an endless elastic belt member, which is wound and stretched on a belt driving roller 41 and a tension roller 42 and rotationally driven with the belt driving roller 41 through contact with the primary transfer backup rollers 51Y, 51M, 51C and 51K and the photoreceptors 10Y, 10M, 10C and 10K.

Monochrome images of plural colors formed in the developing parts 30Y, 30M, 30C and 30K are transferred sequentially to the intermediate transfer part 40 with the primary transfer backup rollers 51Y, 51M, 51C and 51K, and the monochrome images of the plural colors are superimposed on each other. According to the operation, a full color developed image (intermediate transfer image) is formed on the intermediate transfer part 40.

The intermediate transfer part 40 retains the monochrome images, which are formed on the plural photoreceptors 10Y, 10M, 10C and 10K and then primarily transferred sequentially to the intermediate transfer part 40, and then secondarily transfers the images at one time to a recording medium F5, such as paper, film and cloth. The recording medium F5 may be a sheet material having rough surface due to fibrous materials thereof, and the elastic belt member is used as the intermediate transfer part 40 for improving the secondary transfer property by following the rough surface of the sheet material upon secondarily transferring the toner image to the recording medium F5.

A cleaning device containing a cleaning blade 46 and a developer recovering part 47 is disposed on the side of the tension roller 42, which stretches the intermediate transfer part 40 along with the belt driving roller 41.

The cleaning blade 46 has a function of scraping and removing the liquid developer attached to the intermediate transfer part 40 after transferring the image to the recording medium P5 with a secondary transfer roller 61.

The developer recovering part 47 has a function of recovering the liquid developer removed with the cleaning blade 46.

An intermediate transfer part squeezing device 52Y is disposed on the downstream side of the primary transfer backup roller 51Y in the moving direction of the intermediate transfer part 40.

The intermediate transfer part squeezing device 52Y is provided as a device for removing an excessive amount of the liquid developer transferred to the intermediate transfer part 40 in the case where the liquid developer transferred is not in a favorable dispersed state.

The intermediate transfer part squeezing device 52Y is constituted by an intermediate transfer part squeezing roller 53Y, a backup roller 54 disposed to face the intermediate transfer part squeezing roller 53Y with the intermediate transfer part 40 intervening between them, a cleaning blade 55Y pressed onto the intermediate transfer part squeezing roller 53Y to clean the surface thereof, and a developer recovering part 15M.

The intermediate transfer part squeezing device 52Y has a function of recovering an excessive amount of the carrier from the developer primarily transferred to the intermediate transfer part 40 to increase the content of the toner particles in the developed image, and a function of recovering an unnecessary fogging toner. The developer recovering part 15M is a recovering mechanism for the carrier recovered by the cleaning blade 14M of the photoreceptor squeezing roller of magenta color disposed on the downstream side in the moving direction of the intermediate transfer part 40, and is also used as a recovering mechanism for the carrier recovered by the cleaning blade 55Y of the intermediate transfer part squeezing roller 53Y. Accordingly, the developer recovering parts 15M, 15C and 15K of the image carrying member squeezing devices of the second or later colors in the moving direction of the intermediate transfer part 40 are used respectively as the developer recovering parts of the intermediate transfer part squeezing parts 52Y, 52M and 52C disposed in the downstream side of the preceding primary transfer backup rollers 51Y, 51M and 51C in the moving direction of the intermediate transfer part 40, whereby the intervals of them can be maintained constant, and the structure is simplified to enable miniaturization.

The secondary transfer unit 60 has a secondary transfer roller 61 disposed to face the belt driving roller 41 with the intermediate transfer part 40 intervening between them, and has a cleaning device containing a cleaning blade 62 for the secondary transfer roller 61 and a developer recovering part 63.

In the secondary transfer unit 60, the recording medium F5 is transported and fed according to the timing when the intermediate transfer image formed by superimposing the monochrome images on the intermediate transfer part 40 reaches the transfer position of the secondary transfer unit 60, and thus the intermediate transfer image is secondarily transferred to the recording medium F5.

The toner image (transferred image) F5a thus transferred to the recording medium F5 in the secondary transfer unit 60 is transported to the fixing part F40 and fixed therein.

The cleaning blade 62 has a function of scraping and removing the liquid developer attached to the secondary transfer roller 61 after transferring the image to the recording medium F5 with the secondary transfer roller 61.

The developer recovering part 63 has a function of recovering the liquid developer removed with the cleaning blade 62.

The developing units 100Y, 100M, 100C and 100K will be described in detail below. The developing unit 100Y will be described as a representative example.

The developing unit 100Y has, as shown in FIG. 6, a liquid developer storing part 31Y, a coating roller 32Y, a restricting blade 33Y, a developer agitating roller 34Y, a developing roller 20Y, a developing roller cleaning blade 21Y and a developer compressing roller (compressing member) 22Y.

The liquid developer storing part 31Y has a function of storing the liquid developer for developing a latent image formed on the photoreceptor 10Y.

The coating roller 32Y has a function of feeding the liquid developer to the developing roller 20Y.

As shown in FIG. 7, the coating roller 32Y is a so-called anilox roller, which is a metallic roller, such as an iron roller, having grooves 32Ya formed uniformly and helically on the surface thereof and having been plated with nickel, and has a diameter of about 25 mm. In this embodiment, as shown in FIG. 7, plural grooves 32Ya are formed slantwise with respect to the rotation direction D2 of the coating roller 32Y by a cutting process, a rolling process or the like.

The coating roller 32Y is in contact with the liquid developer while rotating clockwise to retain the liquid developer stored in the liquid developer storing part 31Y in the grooves 32Ya, and transports the retained liquid developer to the developing roller 20Y. Accordingly, the coating roller 32Y can coat the liquid developer onto the developing roller 20Y with the width in the X direction where the grooves 32Ya are formed.

The pitch of the grooves (i.e., the interval of the protrusions 32Yb constituting the grooves 32Ya in the X direction shown in FIG. 8) is preferably from 55 to 250 μm depending on the desired thickness of the layer of the liquid developer. In this embodiment, the pitch P of the groove is about 80 μm, the width of the protrusion is about 40 μm, the width PI1 of the upper part of the groove 32Ya is about 50 μm, the width PI2 of the bottom part of the groove 32Ya is about 30 μm, the depth He of the groove 32Ya is about 20 μm, the height Ha of the protrusion 32Yb is about 30 μm, and a slope SL is formed monotonically from the center of the protrusion 32Yb toward the bottom of the groove 32Ya. In this embodiment, the surface roughness Rz of the protrusion 32Yb R1a is about 1.0 μm, and the surface roughness Rz of the groove 32Ya R2a is about 1.0 μm.

In the case where a liquid developer having been used in the art is applied to an image forming apparatus equipped with the coating roller having the aforementioned grooves, there has been a problem in that an image formed suffers the significant unevenness, but application of the liquid developer according to an aspect of the invention to the image forming apparatus effectively prevents or suppress the unevenness in image from being generated.

The restricting blade 33Y is in contact with the surface of the coating roller 32Y to restrict the amount of the liquid developer D on the coating roller 32Y. Specifically, the restricting blade 33Y scrapes the excessive liquid developer on the coating roller 32Y to quantitate the liquid developer D on the coating roller 32Y, which is to be fed to the developing roller 20Y. The restricting blade 33Y is formed of urethane rubber as an elastic material and supported with a restricting blade supporting member formed of a metal, such as iron. The restricting blade 33Y is provided on the side where the coating roller 32Y is rotated to come out from the liquid developer D as viewed from the vertical plane A (i.e., on the left side as viewed from the vertical plane A in FIG. 6). The restricting blade 33Y has a rubber hardness of about 77 according to JIS-A, and the hardness of the restricting blade 33Y at the part in contact with the surface of the coating roller 32Y (about 77) is lower than the hardness of the developing roller 20Y described later at the part in contact with the surface of the coating roller 32Y (about 85).

The developer agitating roller 34Y has a function of agitating the liquid developer to form a uniform dispersed state.

In the liquid developer storing part 31Y, the toner particles in the liquid developer have positive charge, and the liquid developer in a uniform dispersed state by agitating with the developer agitating roller 34Y is drawn up from the liquid developer storing part 31Y through rotation of the coating roller 32Y, and then fed to the developing roller 20Y after restricting the amount of the liquid developer with the restricting blade 33Y.

The developing roller 20Y retains the liquid developer and transports the liquid developer to the developing position facing the photoreceptor 10Y for developing the latent image carried on the photoreceptor 10Y with the liquid developer.

The developing roller 20Y has a liquid developer layer 201Y formed on the surface thereof by feeding the liquid developer from the coating roller 32Y.

The developing roller 20Y has an inner core constituted by a metal, such as iron, having thereon an electroconductive elastic layer, and has a diameter of about 20 mm. The elastic layer has a two-layer structure containing a urethane rubber layer having a rubber hardness of about 30 according to JIS-A and a thickness of about 5 mm as an inner layer, and a urethane rubber layer having a rubber hardness of about 85 according to JIS-A and a thickness of about 30 mm as a surface (outer) layer. The developing roller 20Y is in contact with the coating roller 32Y and the photoreceptor 10Y with the surface layer as a contact part under pressure in an elastically deformed state.

The developing roller 20Y is rotatable with the center axis thereof as the center, and the center axis is positioned downward with respect to the center rotation axis of the photoreceptor 10Y. The developing roller 20Y is rotated in the direction (i.e., the anticlockwise direction in FIG. 6) opposite to the rotation direction (i.e., the clockwise direction in FIG. 6) of the photoreceptor 10Y. An electric field is formed between the developing roller 20Y and the photoreceptor 10Y upon developing the latent image formed on the photoreceptor 10Y.

The developer compressing roller 22Y is a device having a function of making the liquid developer retained by the developing roller 20Y into a compressed state. In other words, the developer compressing roller 22Y is a device having a function of applying an electric field having the same polarity as the toner particles 1 to the liquid developer layer 201Y, thereby localizing the toner particles 1 to the vicinity of the surface of the developing roller 20Y within the liquid developer layer 201Y as shown in FIG. 9. By localizing toner particles in this manner, the developing density (developing efficiency) can be improved, and a sharp image with high quality can be obtained thereby.

A cleaning blade 23Y is provided on the developer compressing roller 22Y.

The cleaning blade 23Y has a function of removing the liquid developer attached to the developer compressing roller 22Y.

The developing unit 100Y has a developing roller cleaning blade 21Y formed of rubber in contact with the surface of the developing roller 20Y. The developing roller cleaning blade 21Y is a device for scraping and removing the liquid developer remaining on the developing roller 20Y after completing development at the developing position. The liquid developer removed by the developing roller cleaning blade 21Y is recovered into the liquid developer storing part 31Y for reuse.

The image forming apparatus 1000 has a reusing device for reusing the insulating liquid contained in the liquid developers recovered to the developer recovering parts 15, 18, 47 and 63.

The reusing device has a transporting path 70, through which the recovered liquid developers are transported from the developer recovering parts, a filter unit 77 that removes solid contents (such as the toner particles) contained in the liquid developers thus transported, and an insulating liquid storing part 74 that stores the insulating liquid, from which solid contents have been removed with the filter unit 77.

A pump 76 is provided on the transporting path 70, and the liquid developers recovered to the developer recovering parts are transported to the insulating liquid storing part 74 with the pump 76.

The insulating liquid thus stored in the insulating liquid storing part 74 is then appropriately transported to the developing parts with a transporting unit, which is not shown in the figures, for reuse.

The solid contents removed by the filter unit 77 are detected by a detecting unit, which is not shown in the figures. The filter unit 77 is exchanged based on the detection result. According to the constitution, the filtering function of the filter unit 77 can be stably maintained.

The invention has been described with reference to the preferred embodiments, but the invention is not construed as being limited thereto.

The insulating liquid according to an aspect of the invention may further contain other components than the fatty acid triglyceride and the fatty acid monoester described above. Examples of the components include a diester (diglyceride) of a diol, such as ethylene glycol and propylene glycol, and a fatty acid. A diester (diglyceride) constituted by one molecule of glycerin and two molecules of a fatty acid, and a monoester (monoglyceride) constituted by one molecule of glycerin and one molecule of a fatty acid may be contained. The insulating liquid containing these components can provide a liquid developer sufficiently providing the aforementioned advantages.

For example, the liquid developer according to an aspect of the invention is not limited to the image forming apparatus and the fixing device described above.

The liquid developer according to an aspect of the invention is not limited to those obtained in the production process described above.

In the aforementioned embodiments, an aqueous dispersion liquid is obtained, and an electrolyte is added to the aqueous emulsion to provide aggregated particles, but the invention is not limited thereto. For example, the aggregated particles may be those obtained by an emulsion polymerization aggregation method, in which a colorant, a monomer, a surfactant and a polymerization initiator are dispersed in an aqueous liquid, an aqueous dispersion liquid is prepared by emulsion polymerization, and an electrolyte is added to the aqueous dispersion liquid to attain aggregation, and may be those obtained by spray-drying the resulting aqueous dispersion liquid to provide the aggregated particles.

### EXAMPLES

### (1) Production of Liquid Developer

### Example 1

80 parts by weight of a polyester resin (softening temperature: 99° C., acid value: 7.0 mgKOH/g) and 20 parts by weight of a cyan pigment (Pigment Blue 15:3, produced by Dainichiseika Color & Chemicals Mfg. Co., Ltd.) were prepared. The components were mixed with a 20-L Henschel mixer to obtain a raw material for producing a toner.

The raw material (mixture) was kneaded with a biaxial kneading extruder. The kneaded product extruded from the extrusion port of the biaxial kneading extruder was cooled.

The kneaded product thus cooled was coarsely pulverized to form powder having an average particle diameter of 1.0 mm or less (coarsely pulverized product). A hammer mill was used for coarsely pulverization of the kneaded product.

100 parts by weight of the coarsely pulverized product, 160 parts by weight of a soybean oil ester exchanged liquid obtained through ester exchange reaction between soybean oil and methanol (Soybean Oil Fatty Acid Methyl Ester, a trade name, produced by The Nisshin OilliO Group, Ltd., acid value: 0.1 mgKOH/g), 2.5 parts by weight of a polyamine-fatty acid polycondensate (Solsperse 13940, produced by Lubrizol Corp. Japan) as a dispersant, and 2.0 parts by weight of a phenol phosphite compound a (tetramidecyl-4,4′-butylidenebis(2-tert-butyl-5-methylphenyl)diphosphite) as a hydrolysis inhibitor were prepared. The fatty acid monoester content of the soybean oil ester exchanged liquid was 99.9% by weight or more.

These components were placed in a ball mill and wet-pulverized for 200 hours to obtain a pulverized product dispersion liquid.

Thereafter, 264.5 parts by weight of the resulting pulverized product dispersion liquid and 240 parts by weight of soybean oil (produced by The Nisshin OilliO Group, Ltd.) were mixed to provide a liquid developer. The fatty acid triglyceride content of the soybean oil was 99.9% by weight or more.

The resulting liquid developer had an average particle diameter of the toner particles of 1.5 μm and a standard deviation of the particle diameter of the toner particles of 0.65 μm. The viscosity of the liquid developer measured according to JIS Z8809 by using a vibration viscometer at 25° C. was 233 mPa·s. Separately, the soybean oil ester exchanged liquid, the soybean oil and the phenol phosphite compound a in the liquid developer were mixed at the mixing ratio in the liquid developer to provide a liquid, which was measured for an acid value according to JIS K2501, and the acid value was 0.07 mgKOH/g. The liquid developer had an electric resistance of 2.1×10¹² Ωcm. The average particle diameters of the toner particles in Examples and Comparative Examples were volume average particle diameters, and the average particle diameters and the particle size distributions of the particles were measured with a particle analyzer, Mastersizer 2000 (produced by Malvern Instruments, Ltd.).

### Examples 2 to 4

Liquid developers were produced in the same manner as in Example 1 except that the contents of the soybean oil ester exchanged liquid and the soybean oil were changed to the values shown in Tables 1-1 to 1-3.

### Example 5

A liquid developer was produced in the same manner as in Example 1 except that a rapeseed oil ester exchanged liquid obtained through ester exchange reaction between rapeseed oil and ethanol (Rapeseed Oil Fatty Acid Ethyl Ester, a trade name, produced by The Nisshin OilliO Group, Ltd., acid value: 0.08 mgKOH/g) was used instead of the soybean oil fatty acid methyl ester.

### Example 6

A liquid developer was produced in the same manner as in Example 1 except that a soybean oil ester exchanged liquid obtained through ester exchange reaction between soybean oil and n-propanol (acid value: 0.07 mgKOH/g) was used instead of the soybean oil fatty acid methyl ester.

### Example 7

A liquid developer was produced in the same manner as in Example 1 except that HO rapeseed oil (produced by The Nisshin OilliO Group, Ltd.) was used instead of the soybean oil.

### Example 8

A liquid developer was produced in the same manner as in Example 1 except that a safflower oil (produced by The Nisshin OilliO Group, Ltd.) and a soybean oil ester exchanged liquid obtained through ester exchange reaction between soybean oil and heptanol were used instead of the soybean oil and the soybean oil fatty acid methyl ester, respectively.

### Example 9

A liquid developer was produced in the same manner as in Example 1 except that a phenol phosphite compound b (tris(2,4-di-tert-butylphenyl)phosphite) was used as a hydrolysis inhibitor instead of the phenol phosphite compound a.

### Example 10

A liquid developer was produced in the same manner as in Example 7 except that the amount of the phenol phosphite compound a placed in the ball mill was changed to 0.1 part by weight.

### Example 11

A liquid developer was produced in the same manner as in Example 1 except that the amount of the phenol phosphite compound a placed in the ball mill was changed to 22.0 parts by weight.

### Example 12

A liquid developer was produced in the same manner as in Example 1 except that a phenol phosphite compound c (triphenyl phosphite) was used as a hydrolysis inhibitor instead of the phenol phosphite compound a, and the amount of the phenol phosphite compound placed in the ball mill was changed to 7.0 parts by weight.

### Example 13

A liquid developer was produced in the same manner as in Example 1 except that a phenol phosphite compound d (diphenyl phosphite) was used as a hydrolysis inhibitor instead of the phenol phosphite compound a, and the amount of the phenol phosphite compound placed in the ball mill was changed to 10.0 parts by weight.

### Example 14

A liquid developer was produced in the same manner as in Example 1 except that an epoxy resin (Epikote 1004, softening temperature: 128° C.) was used instead of the polyester resin.

### Example 15

80 parts by weight of a polyester resin (softening temperature: 99° C.) and 20 parts by weight of a cyan pigment (Pigment Blue 15:3, produced by Dainichiseika Color & Chemicals Mfg. Co., Ltd.) were prepared. The components were mixed with a 20-L Henschel mixer to obtain a raw material for producing a toner.

The raw material (mixture) was kneaded with a biaxial kneading extruder. The kneaded product extruded from the extrusion port of the biaxial kneading extruder was cooled.

The kneaded product thus cooled was coarsely pulverized to form powder having an average particle diameter of 1.0 mm or less (coarsely pulverized product). A hammer mill was used for pulverization of the kneaded product.

100 parts by weight of the coarsely pulverized product of the kneaded product was added to 250 parts by weight of toluene, and treated with an ultrasonic homogenizer (output: 400 μA) for 1 hour to provide a solution having the polyester resin of the kneaded product dissolved therein (toner material solution). The pigment was finely dispersed uniformly in the solution.

1 part by weight of sodium dodecylbenzenesulfonate as a dispersant and 700 parts by weight of ion exchanged water were mixed uniformly to provide an aqueous liquid.

The aqueous liquid was agitated with a homomixer (produced by Tokushu Kika Kogyo Co., Ltd.) with the agitation rotation number being regulated.

The toner material solution was added dropwise to the aqueous liquid under agitating. According to the operation, an aqueous emulsion liquid having a dispersoid having an average particle diameter of 0.5 μm dispersed therein was obtained.

Thereafter, toluene was removed from the aqueous emulsion liquid under the conditions of a temperature of 100° C. and an atmospheric pressure of 80 kPa, and after cooling to room temperature, a prescribed amount of water was added thereto to regulate the concentration, whereby an aqueous dispersion liquid having solid fine particles dispersed therein was obtained. The resulting aqueous dispersion liquid contained substantially no toluene. The resulting aqueous dispersion liquid had a concentration of the solid content (dispersoid) of 20% by weight. The dispersoid (solid fine particles) dispersed in the dispersion liquid had an average particle diameter of 0.5 μm. The average particle diameter of the dispersoid was measured by using a laser diffraction/scattering particle size distribution measuring device (LA-920, produced by Horiba, Ltd.).

0.35 part by weight of a nonionic surfactant (Epan 450, a trade name, produced by Dai-ichi Kogyo Seiyaku Co., Ltd.) was added to 100 parts by weight of the resulting aqueous dispersion liquid under agitating.

After regulating the agitation speed and the temperature to 30° C., 35 parts by weight of a 3% ammonium sulfate aqueous solution was added dropwise to 100 parts by weight of the aqueous dispersion liquid. According to the operation, an aggregated particle dispersion liquid having aggregated particles dispersed therein was obtained.

The aggregated particles were separated from the resulting aggregated particle dispersion liquid by centrifugal separation, washed and dried in a vacuum dryer to provide aggregated particles. The resulting aggregated particles had an average particle diameter of 5.2 μm.

Chromium carbide beads having a diameter of 4 mm were placed in a 500-mL vessel, and 150 parts by weight of a soybean oil ester exchanged liquid obtained through ester exchange reaction between soybean oil and methanol (Soybean Oil Fatty Acid Methyl Ester, a trade name, produced by The Nisshin OilliO Group, Ltd., acid value: 0.1 mgKOH/g) and 2.5 parts by weight of a polyamine-fatty acid polycondensate (Solsperse 13940, produced by Lubrizol Corp. Japan) as a dispersant were placed therein.

100 parts by weight of the resulting aggregated particles were placed in the vessel, and mixed with a ball mill for 10 minutes, followed by crashing with a ball mill for 200 hours, to provide a toner dispersion liquid.

After completing the crashing operation, 225 parts by weight of HO rapeseed oil, 1.4 parts by weight of zinc oxide (average particle diameter: 1.0 μm) as a charge controlling agent, and 2.0 parts by weight of a phenol phosphite compound a as a hydrolysis inhibitor were added thereto, followed by dispersing the toner particles. The dispersion operation was carried out by using a ball mill with 1-mm beads for 24 hours. According to the operation, a liquid developer was obtained.

The resulting liquid developer had an average particle diameter of the toner particles of 1.2 μm and a standard deviation of the particle diameter of the toner particles of 0.50 μm. The viscosity of the liquid developer measured according to JIS Z8809 by using a vibration viscometer at 25° C. was 219 mPa·s. The liquid developer had an electric resistance of 2.1×10¹² Ωcm.

### Example 16

A liquid developer was produced in the same manner as in Example 15 except that a safflower oil ester exchanged liquid obtained through ester exchange reaction between safflower oil and methanol was used instead of the soybean oil fatty acid methyl ester.

### Example 17

150 parts by weight of the soybean oil ester exchanged liquid, 225 parts by weight of the HO rapeseed oil, 2.5 parts by weight of the polyamine-fatty acid polycondensate, 2.0 parts by weight of the phenol phosphite compound a and 1.4 parts by weight of zinc oxide, which were used in Example 15, were mixed to provide an insulating liquid. 380.9 parts by weight of the resulting insulating liquid and 100 parts by weight of the aggregated particles obtained in Example 15 were mixed with the ball mill used in Example 15 for 10 minutes, followed by crashing with the ball mill for 400 hours, to provide a liquid developer.

### Example 18

A liquid developer was produced in the same manner as in Example 1 except that the phenol phosphite compound a was not placed in the ball mill.

### Example 19

A liquid developer was produced in the same manner as in Example 18 except that a soybean oil fatty acid methyl ester having an acid value of 20 mgKOH/g was used as the soybean oil fatty acid methyl ester.

### Example 20

A liquid developer was produced in the same manner as in Example 15 except that a soybean oil ester exchanged liquid obtained through ester exchange reaction between soybean oil and n-octyl alcohol was used instead of the soybean oil fatty acid methyl ester.

### Example 21

A liquid developer was produced in the same manner as in Example 1 except that a soybean oil ester exchanged liquid obtained through ester exchange reaction between soybean oil and n-octyl alcohol was used instead of the soybean oil fatty acid methyl ester.

### Example 22

A liquid developer was produced in the same manner as in Example 7 except that the phenol phosphite compound a was not placed in the ball mill.

### Example 23

A liquid developer was produced in the same manner as in Example 22 except that ethyl linoleate (acid value: 0.2 mgKOH/g) obtained through ester exchange reaction between linoleic acid and ethanol as a primary alcohol was used instead of the soybean oil fatty acid methyl ester.

### Example 24

80 parts by weight of a polyester resin (softening temperature: 99° C., acid value: 7.0 mgKOH/g) and 20 parts by weight of a cyan pigment (Pigment Blue 15:3, produced by Dainichiseika Color & Chemicals Mfg. Co., Ltd.) were prepared. The components were mixed with a 20-L Henschel mixer to obtain a raw material for producing a toner.

The raw material (mixture) was kneaded with a biaxial kneading extruder. The kneaded product extruded from the extrusion port of the biaxial kneading extruder was cooled.

The kneaded product thus cooled was coarsely pulverized to form powder having an average particle diameter of 1.0 mm or less (coarsely pulverized product). A hammer mill was used for pulverization of the kneaded product.

100 parts by weight of the coarsely pulverized product, 160 parts by weight of a soybean oil ester exchanged liquid obtained through ester exchange reaction between soybean oil and isopropanol as a secondary alcohol (soybean oil fatty acid isopropyl ester, acid value: 0.1 mgKOH/g) and 2.5 parts by weight of a polyamine-fatty acid polycondensate (Solsperse 13940, produced by Lubrizol Corp. Japan) as a dispersant were prepared. The fatty acid monoester content of the ester exchanged liquid was 99.9% by weight or more.

These components were placed in a ball mill and wet-pulverized for 200 hours to obtain a pulverized product dispersion liquid.

Thereafter, 264.5 parts by weight of the resulting pulverized product dispersion liquid and 240 parts by weight of HO rapeseed oil (produced by The Nisshin OilliO Group, Ltd.) were mixed to provide a liquid developer. The fatty acid triglyceride content of the HO rapeseed oil was 99.9% by weight or more.

The resulting liquid developer had an average particle diameter of the toner particles of 1.5 μm and a standard deviation of the particle diameter of the toner particles of 0.65 μm. The viscosity of the liquid developer measured according to JIS Z8809 by using a vibration viscometer at 25° C. was 312 mPa·s. Separately, the soybean oil ester exchanged liquid and the HO rapeseed oil in the liquid developer were mixed at the mixing ratio in the liquid developer to provide a liquid, which was measured for an acid value according to JIS K2501, and the acid value was 0.1 mgKOH/g. The liquid developer had an electric resistance of 3.1×10¹² Ωcm.

### Examples 25 to 32

Liquid developers were produced in the same manner as in Example 24 except that at least one of the using amounts of the fatty acid monoester and the fatty acid triglyceride, and the raw materials used for producing them were changed.

### Example 33

80 parts by weight of a polyester resin (softening temperature: 99° C.) and 20 parts by weight of a cyan pigment (Pigment Blue 15:3, produced by Dainichiseika Color & Chemicals Mfg. Co., Ltd.) as a colorant were prepared. The components were mixed with a 20-L Henschel mixer to obtain a raw material for producing a toner.

The raw material (mixture) was kneaded with a biaxial kneading extruder. The kneaded product extruded from the extrusion port of the biaxial kneading extruder was cooled.

The kneaded product thus cooled was coarsely pulverized to form powder having an average particle diameter of 1.0 mm or less (coarsely pulverized product). A hammer mill was used for pulverization of the kneaded product.

100 parts by weight of the coarsely pulverized product of the kneaded product was added to 250 parts by weight of toluene, and treated with an ultrasonic homogenizer (output: 400 μA) for 1 hour to provide a solution having the polyester resin of the kneaded product dissolved therein (toner material solution). The pigment was finely dispersed uniformly in the solution.

1 part by weight of sodium dodecylbenzenesulfonate as a dispersant and 700 parts by weight of ion exchanged water were mixed uniformly to provide an aqueous liquid.

The aqueous liquid was agitated with a homomixer (produced by Tokushu Kika Kogyo Co., Ltd.) with the agitation rotation number being regulated.

The toner material solution was added dropwise to the aqueous liquid under agitating. According to the operation, an aqueous emulsion liquid having a dispersoid having an average particle diameter of 0.5 μm dispersed therein was obtained.

Thereafter, toluene was removed from the aqueous emulsion liquid under the conditions of a temperature of 100° C. and an atmospheric pressure of 80 kPa, and after cooling to room temperature, a prescribed amount of water was added thereto to regulate the concentration, whereby an aqueous dispersion liquid having solid fine particles dispersed therein was obtained. The resulting aqueous dispersion liquid contained substantially no toluene. The resulting aqueous dispersion liquid had a concentration of the solid content (dispersoid) of 20% by weight. The dispersoid (solid fine particles) dispersed in the dispersion liquid had an average particle diameter of 0.5 μm. The average particle diameter of the dispersoid was measured by using a laser diffraction/scattering particle size measuring device (LA-920, produced by Horiba, Ltd.).

0.35 part by weight of a nonionic surfactant (Epan 450, a trade name, produced by Dai-ichi Kogyo Seiyaku Co., Ltd.) was added to 100 parts by weight of the resulting aqueous dispersion liquid under agitating.

After regulating the agitation speed and the temperature to 30° C., 35 parts by weight of a 3% ammonium sulfate aqueous solution was added dropwise to 100 parts by weight of the aqueous dispersion liquid. According to the operation, an aggregated particle dispersion liquid having aggregated particles dispersed therein was obtained.

The aggregated particles were separated from the resulting aggregated particle dispersion liquid by centrifugal separation, washed and dried in a vacuum dryer to provide aggregated particles. The resulting aggregated particles had an average particle diameter of 5.2 μm.

Chromium carbide beads having a diameter of 4 mm were placed in a 500-mL vessel, and 150 parts by weight of a soybean oil ester exchanged liquid obtained through ester exchange reaction between soybean oil and isopropanol (soybean oil fatty acid isopropyl ester, acid value: 0.1 mgKOH/g) and 2.5 parts by weight of a polyamine-fatty acid polycondensate (Solsperse 13940, produced by Lubrizol Corp. Japan) as a dispersant were placed therein.

100 parts by weight of the resulting aggregated particles were placed in the vessel, and mixed with a ball mill for 10 minutes, followed by crashing with a ball mill for 200 hours, to provide a toner dispersion liquid.

After completing the crashing operation, 225 parts by weight of HO rapeseed oil was added thereto, followed by dispersing the toner particles. The dispersion operation was carried out by using a ball mill with 1-mm beads for 24 hours. According to the operation, a liquid developer was obtained.

The resulting liquid developer had an average particle diameter of the toner particles of 1.2 μm and a standard deviation of the particle diameter of the toner particles of 0.50 μm. The viscosity of the liquid developer measured according to JIS Z8809 by using a vibration viscometer at 25° C. was 232 mPa·s. The liquid developer had an electric resistance of 2.6×10¹² Ωcm.

### Example 34

A liquid developer was produced in the same manner as in Example 33 except that a safflower oil ester exchanged liquid (safflower oil fatty acid tert-pentyl ester, acid value: 0.08 mgKOH/g) obtained through ester exchange reaction between safflower oil and 1,1-dimethyl-1-propanol(tert-pentanol) as a tertiary alcohol was used instead of the soybean oil fatty acid isopropyl ester.

### Example 35

150 parts by weight of the soybean oil fatty acid isopropyl ester, 225 parts by weight of the HO rapeseed oil, 2.5 parts by weight of the polyamine-fatty acid polycondensate and 1.4 parts by weight of zinc oxide, which were used in Example 33, were mixed to provide an insulating liquid. 380.9 parts by weight of the resulting insulating liquid and 100 parts by weight of the aggregated particles obtained in Example 10 were mixed with the ball mill used in Example 10 for 10 minutes, followed by crashing with the ball mill for 400 hours, to provide a liquid developer.

### Examples 36 and 37

Liquid developers were produced in the same manner as in Example 7 except that the kind and content of the fatty acid monoester contained in the insulating liquid and the content of the phenol phosphite compound a contained therein were changed as shown in Tables 1-1 to 1-3.

### Comparative Example 1

A liquid developer was produced in the same manner as in Example 1 except that a soybean oil ester exchanged liquid obtained through ester exchange reaction between soybean oil and n-nonyl alcohol was used instead of the soybean oil fatty acid methyl ester.

### Comparative Example 2

A liquid developer was produced in the same manner as in Example 24 except that the kind of the fatty acid monoester used was changed as shown in Tables 2-1 to 2-3.

### Comparative Example 3

A liquid developer was produced in the same manner as in Example 30 except that soybean oil was used instead of the soybean oil fatty acid isopropyl ester.

### Comparative Example 4

A liquid developer was produced in the same manner as in Example 24 except that a soybean oil ester exchanged liquid obtained through ester exchange reaction between soybean oil and isopropanol (soybean oil fatty acid isopropyl ester, acid value: 0.1 mgKOH/g) was used instead of the HO rapeseed oil.

### Comparative Example 5

A coarsely pulverized product was obtained in the same manner as in Example 1.

100 parts by weight of the resulting coarsely pulverized product, 160 parts by weight of soybean oil (produced by The Nisshin OilliO Group, Ltd.), 2.5 parts by weight of a polyamine-fatty acid polycondensate (Solsperse 13940, produced by Lubrizol Corp. Japan) as a dispersant, and 2.0 parts by weight of a phenol phosphite compound a were prepared.

These components were placed in a ball mill and wet-pulverized for 400 hours to obtain a pulverized product dispersion liquid.

Thereafter, 264.5 parts by weight of the resulting pulverized product dispersion liquid, 240 parts by weight of soybean oil and 1.4 parts by weight of zinc oxide (average particle diameter: 1.0 μm) as a charge controlling agent were mixed to provide a liquid developer.

The resulting liquid developer had an average particle diameter of the toner particles of 4.8 μm and a standard deviation of the particle diameter of the toner particles of 2.92 μm. The viscosity of the liquid developer measured according to JIS Z8809 by using a vibration viscometer at 25° C. was 595 mPa·s. The insulating liquid had an electric resistance of 1.6×10¹³ Ωcm. The liquid developer had an electric resistance of 4.6×10¹² Ωcm.

### Comparative Example 6

A liquid developer was produced in the same manner as in Example 1 except that both the soybean oil and the soybean oil ester exchanged liquid were replaced by Isopar H (produced by Exxon Mobil Corp.).

For Examples and Comparative Examples described above, the kind of the resin used; the raw materials, the content in the insulating liquid, and the kind and the content of the fatty acid component contained of the fatty acid triglyceride; the raw materials, the content in the insulating liquid, the kind and the content of the fatty acid component contained, and the kind of the alcohol component contained of the fatty acid monoester; and the viscosity and the electric resistance of the liquid developer; and the like are shown in Tables 1-1 to 1-3 and 2-1 to 2-3.

In Tables 1-1 to 1-3 and 2-1 to 2-3, the polyester resin is represented by PEs, the epoxy resin is represented by EP, methanol is represented by MeOH, ethanol is represented by EtOH, n-propanol is represented by n-PrOH, heptanol is represented by HepOH, n-octyl alcohol is represented by OctOH, n-nonyl alcohol is represented by NonOH, isopropanol is represented by i-PrOH, 2-butanol(sec-butanol) is represented by 2-BuOH, 1,1-diethyl-3-methyl-1-propanol(tert-octanol) is represented by tert-OctOH, 1,1-dimethyl-1-propanol(tert-pentanol) is represented by t-PeOH, 7-methyl-1-octanol is represented by 7-Me-1-OctOH, and as a hydrolysis inhibitor, the phenol phosphite compound a is represented by a, the phenol phosphite compound b is represented by b, the phenol phosphite compound c is represented by c, and the phenol phosphite compound d is represented by d.

The viscosity and the electric resistance in Tables 1-1 to 1-3 and 2-1 to 2-3 are expressed based on the following four grades, respectively.

### Viscosity

### A: 150 mPa·s or more and 800 mPa·s or less

### B: 100 mPa·s or more and 900 mPa·s or less (except for 150 mPa·s or more and 800 mPa·s or less)

### C: 50 mPa·s or more and less than 1,000 mPa·s (except for 100 mPa·s or more and 900 mPa·s or less)

### D: less than 50 mPa·s or more than 1,000 mPa·s

### Electric Resistance

### A: 2.0×10¹² Ωcm or more

### B: 1.5×10¹² Ωcm or more and less than 2.0×10¹² Ωm

### C: 1.0×10¹² Ωcm or more and less than 1.5×10¹² Ωcm

### D: less than 1.0×10¹² Ωcm

TABLE 1-1

| | | | | Insulating liquid | | | | |
|---|---|---|---|---|---|---|---|---|
| | | | | Fatty acid triglyceride | | | | |
| | | | | | Unsaturated fatty acid | | | |
| | | | | | component | | | |
| | | | | | | Content of | | |
| | | | | | Content of | divalent or | | |
| | | | | | monovalent | higher | Content of | |
| | Resin material | | | Raw | unsaturated | unsaturated | saturated | |
| | | Softening | | material | fatty acid | fatty acid | fatty acid | Content X |
| | | temperature | Acid value | (vegetable | component | component | component | (% by |
| | Kind | (° C.) | (mgKOH/g) | oil) | (% by mol) | (% by mol) | (% by mol) | weight) |
| Example 1 | PEs | 99 | 7 | soybean oil | 23.8 | 60.1 | 16.1 | 59.7 |
| Example 2 | PEs | 99 | 7 | soybean oil | 23.8 | 60.1 | 16.1 | 69.9 |
| Example 3 | PEs | 99 | 7 | soybean oil | 23.8 | 60.1 | 16.1 | 90.8 |
| Example 4 | PEs | 99 | 7 | soybean oil | 23.8 | 60.1 | 16.1 | 56 |
| Example 5 | PEs | 99 | 7 | soybean oil | 23.8 | 60.1 | 16.1 | 59.7 |
| Example 6 | PEs | 99 | 7 | soybean oil | 23.8 | 60.1 | 16.1 | 59.7 |
| Example 7 | PEs | 99 | 7 | HO rapeseed | 75 | 17.4 | 7.6 | 59.7 |
| | | | | oil | | | | |
| Example 8 | PEs | 99 | 7 | safflower | 14 | 75.9 | 10.1 | 59.7 |
| | | | | oil | | | | |
| Example 9 | PEs | 99 | 7 | soybean oil | 23.8 | 60.1 | 16.1 | 59.7 |
| Example 10 | PEs | 99 | 7 | HO rapeseed | 75 | 17.4 | 7.6 | 59.99 |
| | | | | oil | | | | |
| Example 11 | PEs | 99 | 7 | soybean oil | 23.8 | 60.1 | 16.1 | 56.9 |
| Example 12 | PEs | 99 | 7 | soybean oil | 23.8 | 60.1 | 16.1 | 59 |
| Example 13 | PEs | 99 | 7 | soybean oil | 23.8 | 60.1 | 16.1 | 58.5 |
| Example 14 | EP | 128 | — | soybean oil | 23.8 | 60.1 | 16.1 | 59.7 |
| Example 15 | PEs | 99 | 7 | HO rapeseed | 75 | 17.4 | 7.6 | 59.7 |
| | | | | oil | | | | |
| Example 16 | PEs | 99 | 7 | HO rapeseed | 75 | 17.4 | 7.6 | 59.7 |
| | | | | oil | | | | |
| Example 17 | PEs | 99 | 7 | HO rapeseed | 75 | 17.4 | 7.6 | 59.7 |
| | | | | oil | | | | |
| Example 18 | PEs | 99 | 7 | soybean oil | 23.8 | 60.1 | 16.1 | 60 |
| Example 19 | PEs | 99 | 7 | soybean oil | 23.8 | 60.1 | 16.1 | 60 |
| Example 20 | PEs | 99 | 7 | HO rapeseed | 75 | 17.4 | 7.6 | 59.7 |
| | | | | oil | | | | |
| Example 21 | PEs | 99 | 7 | soybean oil | 23.8 | 60.1 | 16.1 | 59.7 |

TABLE 1-2

| | Insulating liquid | | | | | | |
|---|---|---|---|---|---|---|---|
| | Fatty acid monoester | | | | | | |
| | | Unsaturated fatty acid | | | | | |
| | | component | | | | | |
| | | | Content of | | | | |
| | | Content of | divalent or | | | | |
| | | monovalent | higher | | | | |
| | | unsaturated | unsaturated | | | | |
| | Raw material | fatty acid | fatty acid | Alcohol used for ester exchange | | | |
| | (vegetable | component | component | | Number of | | Content Y |
| | oil) | (% by mol) | (% by mol) | Kind | carbon atoms | Class | (% by weight) |
| Example 1 | soybean oil | 23.8 | 60.1 | MeOH | 1 | primary | 39.8 |
| Example 2 | soybean oil | 23.8 | 60.1 | MeOH | 1 | primary | 29.6 |
| Example 3 | soybean oil | 23.8 | 60.1 | MeOH | 1 | primary | 8.7 |
| Example 4 | soybean oil | 23.8 | 60.1 | MeOH | 1 | primary | 43.5 |
| Example 5 | rapeseed oil | 64.4 | 28 | EtOH | 2 | primary | 39.8 |
| Example 6 | soybean oil | 23.8 | 60.1 | n-PrOH | 3 | primary | 39.8 |
| Example 7 | soybean oil | 23.8 | 60.1 | MeOH | 1 | primary | 39.8 |
| Example 8 | soybean oil | 23.8 | 60.1 | HepOH | 7 | primary | 39.8 |
| Example 9 | soybean oil | 23.8 | 60.1 | MeOH | 1 | primary | 39.8 |
| Example 10 | soybean oil | 23.8 | 60.1 | MeOH | 1 | primary | 39.99 |
| Example 11 | soybean oil | 23.8 | 60.1 | MeOH | 1 | primary | 37.9 |
| Example 12 | soybean oil | 23.8 | 60.1 | MeOH | 1 | primary | 39.3 |
| Example 13 | soybean oil | 23.8 | 60.1 | MeOH | 1 | primary | 39 |
| Example 14 | soybean oil | 23.8 | 60.1 | MeOH | 1 | primary | 39.8 |
| Example 15 | soybean oil | 23.8 | 60.1 | MeOH | 1 | primary | 39.8 |
| Example 16 | safflower oil | 14 | 75.9 | MeOH | 1 | primary | 39.8 |
| Example 17 | soybean oil | 23.8 | 60.1 | MeOH | 1 | primary | 39.8 |
| Example 18 | soybean oil | 23.8 | 60.1 | MeOH | 1 | primary | 40 |
| Example 19 | soybean oil | 23.8 | 60.1 | MeOH | 1 | primary | 40 |
| Example 20 | soybean oil | 23.8 | 60.1 | OctOH | 8 | primary | 39.8 |
| Example 21 | soybean oil | 23.8 | 60.1 | OctOH | 8 | primary | 39.8 |

TABLE 1-3

| | Insulating liquid | | | | | |
|---|---|---|---|---|---|---|
| | Hydrolysis inhibitor | | | | | |
| | | Content | | Acid value | | Electric |
| | Kind | (% by weight) | X/Y | (mgKOH/g) | Viscosity | resistance |
| Example 1 | a | 0.5 | 1.5 | 0.07 | A | A |
| Example 2 | a | 0.5 | 2.4 | 0.08 | A | A |
| Example 3 | a | 0.5 | 10.4 | 0.11 | A | A |
| Example 4 | a | 0.5 | 1.3 | 0.05 | B | A |
| Example 5 | a | 0.5 | 1.5 | 0.04 | A | A |
| Example 6 | a | 0.5 | 1.5 | 0.16 | A | A |
| Example 7 | a | 0.5 | 1.5 | 0.06 | A | A |
| Example 8 | a | 0.5 | 1.5 | 0.13 | A | A |
| Example 9 | b | 0.5 | 1.5 | 0.18 | A | A |
| Example 10 | a | 0.02 | 1.5 | 0.21 | A | A |
| Example 11 | a | 5.2 | 1.5 | 0.09 | A | A |
| Example 12 | c | 1.7 | 1.5 | 0.12 | A | A |
| Example 13 | d | 2.4 | 1.5 | 0.24 | A | A |
| Example 14 | a | 0.5 | 1.5 | 0.15 | A | A |
| Example 15 | a | 0.5 | 1.5 | 0.18 | A | A |
| Example 16 | a | 0.5 | 1.5 | 0.2 | A | A |
| Example 17 | a | 0.5 | 1.5 | 0.05 | A | A |
| Example 18 | — | — | 1.5 | 4 | A | A |
| Example 19 | — | — | 1.5 | 15 | A | A |
| Example 20 | a | 0.5 | 1.5 | 5 | A | A |
| Example 21 | a | 0.5 | 1.5 | 0.07 | A | A |

TABLE 2-1

| | | | | Insulating liquid | | | | |
|---|---|---|---|---|---|---|---|---|
| | | | | Fatty acid triglyceride | | | | |
| | | | | | Unsaturated fatty acid | | | |
| | | | | | component | | | |
| | | | | | | Content of | | |
| | | | | | Content of | divalent or | | |
| | | | | | monovalent | higher | Content of | |
| | Resin material | | | Raw | unsaturated | unsaturated | saturated | |
| | | Softening | | material | fatty acid | fatty acid | fatty acid | Content X |
| | | temperature | Acid value | (vegetable | component | component | component | (% by |
| | Kind | (° C.) | (mgKOH/g) | oil) | (% by mol) | (% by mol) | (% by mol) | weight) |
| Example 22 | PEs | 99 | 7 | HO rapeseed | 75 | 17.4 | 7.6 | 60 |
| | | | | oil | | | | |
| Example 23 | PEs | 99 | 7 | HO rapeseed | 75 | 17.4 | 7.6 | 60 |
| | | | | oil | | | | |
| Example 24 | PEs | 99 | 7 | HO rapeseed | 75 | 17.4 | 7.6 | 60 |
| | | | | oil | | | | |
| Example 25 | PEs | 99 | 7 | HO rapeseed | 75 | 17.4 | 7.6 | 70.6 |
| | | | | oil | | | | |
| Example 26 | PEs | 99 | 7 | HO rapeseed | 75 | 17.4 | 7.6 | 91.3 |
| | | | | oil | | | | |
| Example 27 | PEs | 99 | 7 | HO rapeseed | 75 | 17.4 | 7.6 | 56.5 |
| | | | | oil | | | | |
| Example 28 | PEs | 99 | 7 | HO rapeseed | 75 | 17.4 | 7.6 | 60 |
| | | | | oil | | | | |
| Example 29 | PEs | 99 | 7 | HO rapeseed | 75 | 17.4 | 7.6 | 60 |
| | | | | oil | | | | |
| Example 30 | PEs | 99 | 7 | soybean oil | 23.8 | 60.1 | 16.1 | 60 |
| Example 31 | PEs | 99 | 7 | safflower | 14 | 75.9 | 10.1 | 60 |
| | | | | oil | | | | |
| Example 32 | EP | 128 | — | HO rapeseed | 75 | 17.4 | 7.6 | 60 |
| | | | | oil | | | | |
| Example 33 | PEs | 99 | 7 | HO rapeseed | 75 | 17.4 | 7.6 | 60 |
| | | | | oil | | | | |
| Example 34 | PEs | 99 | 7 | HO rapeseed | 75 | 17.4 | 7.6 | 60 |
| | | | | oil | | | | |
| Example 35 | PEs | 99 | 7 | HO rapeseed | 75 | 17.4 | 7.6 | 60 |
| | | | | oil | | | | |
| Example 36 | PEs | 99 | 7 | HO rapeseed | 75 | 17.4 | 7.6 | 59.9 |
| | | | | oil | | | | |
| Example 37 | PEs | 99 | 7 | HO rapeseed | 75 | 17.4 | 7.6 | 59.9 |
| | | | | oil | | | | |
| Comparative | PEs | 99 | 7 | soybean oil | 23.8 | 60.1 | 16.1 | 59.7 |
| Example 1 | | | | | | | | |
| Comparative | PEs | 99 | 7 | HO rapeseed | 75 | 17.4 | 7.6 | 60 |
| Example 2 | | | | oil | | | | |
| Comparative | PEs | 99 | 7 | soybean oil | 23.8 | 60.1 | 16.1 | 100 |
| Example 3 | | | | | | | | |
| Comparative | PEs | 99 | 7 | — | — | — | — | 0 |
| Example 4 | | | | | | | | |
| Comparative | PEs | 99 | 7 | soybean oil | 23.8 | 60.1 | 16.1 | 99.5 |
| Example 5 | | | | | | | | |
| Comparative | PEs | 99 | 7 | — | — | 0 | — | 0 |
| Example 6 | | | | | | | | |

TABLE 2-2

| | Insulating liquid | | | | | | |
|---|---|---|---|---|---|---|---|
| | Fatty acid monoester | | | | | | |
| | | Unsaturated fatty acid | | | | | |
| | | component | | | | | |
| | | | Content of | | | | |
| | | Content of | divalent or | | | | |
| | | monovalent | higher | | | | |
| | | unsaturated | unsaturated | | | | |
| | Raw material | fatty acid | fatty acid | Alcohol used for ester exchange | | | |
| | (vegetable | component | component | | Number of | | Content Y |
| | oil) | (% by mol) | (% by mol) | Kind | carbon atoms | Class | (% by weight) |
| Example 22 | soybean oil | 23.8 | 60.1 | MeOH | 1 | primary | 40 |
| Example 23 | — | — | 100 | EtOH | 2 | primary | 40 |
| Example 24 | soybean oil | 23.8 | 60.1 | i-PrOH | 3 | secondary | 40 |
| Example 25 | soybean oil | 23.8 | 60.1 | i-PrOH | 3 | secondary | 29.4 |
| Example 26 | soybean oil | 23.8 | 60.1 | i-PrOH | 3 | secondary | 8.7 |
| Example 27 | soybean oil | 23.8 | 60.1 | i-PrOH | 3 | secondary | 43.5 |
| Example 28 | soybean oil | 23.8 | 60.1 | 2-BuOH | 4 | secondary | 40 |
| Example 29 | soybean oil | 23.8 | 60.1 | t-OctOH | 8 | tertiary | 40 |
| Example 30 | soybean oil | 23.8 | 60.1 | i-PrOH | 3 | secondary | 40 |
| Example 31 | soybean oil | 23.8 | 60.1 | i-BuOH | 4 | primary | 40 |
| Example 32 | soybean oil | 23.8 | 60.1 | i-PrOH | 3 | secondary | 40 |
| Example 33 | soybean oil | 23.8 | 60.1 | i-PrOH | 3 | secondary | 40 |
| Example 34 | safflower oil | 14 | 75.9 | t-PeOH | 5 | tertiary | 40 |
| Example 35 | soybean oil | 23.8 | 60.1 | i-PrOH | 3 | secondary | 40 |
| Example 36 | soybean oil | 23.8 | 60.1 | i-PrOH | 3 | secondary | 39.9 |
| Example 37 | soybean oil | 23.8 | 60.1 | i-PrOH | 3 | secondary | 39.9 |
| Comparative | soybean oil | 23.8 | 60.1 | n-NonOH | 9 | primary | 39.8 |
| Example 1 | | | | | | | |
| Comparative | soybean oil | 23.8 | 60.1 | 7-Me-1-OctOH | 9 | primary | 40 |
| Example 2 | | | | | | | |
| Comparative | — | — | — | — | — | — | 0 |
| Example 3 | | | | | | | |
| Comparative | soybean oil | 23.8 | 60.1 | i-PrOH | 3 | secondary | 40 |
| Example 4 | | | | | | | |
| Comparative | — | — | — | — | — | — | 0 |
| Example 5 | | | | | | | |
| Comparative | — | — | — | — | — | — | 0 |
| Example 6 | | | | | | | |

TABLE 2-3

| | Insulating liquid | | | | | |
|---|---|---|---|---|---|---|
| | Hydrolysis inhibitor | | | | | |
| | | Content | | Acid value | | Electric |
| | Kind | (% by weight) | X/Y | (mgKOH/g) | Viscosity | resistance |
| Example 22 | — | — | 1.5 | 20 | A | A |
| Example 23 | — | — | 1.5 | 0.1 | A | A |
| Example 24 | — | — | 1.5 | 0.1 | A | A |
| Example 25 | — | — | 2.4 | 0.1 | A | A |
| Example 26 | — | — | 10.5 | 0.1 | A | A |
| Example 27 | — | — | 1.3 | 0.1 | B | A |
| Example 28 | — | — | 1.5 | 0.08 | A | A |
| Example 29 | — | — | 1.5 | 0.07 | A | A |
| Example 30 | — | — | 1.5 | 0.1 | A | A |
| Example 31 | — | — | 1.5 | 0.15 | A | A |
| Example 32 | — | — | 1.5 | 0.1 | A | A |
| Example 33 | — | — | 1.5 | 0.1 | A | A |
| Example 34 | — | — | 1.5 | 0.08 | A | A |
| Example 35 | — | — | 1.5 | 0.1 | A | A |
| Example 36 | a | 0.12 | 1.5 | 0.2 | A | A |
| Example 37 | a | 0.5 | 1.5 | 0.2 | A | A |
| Comparative | a | 0.5 | 1.5 | 0.07 | D | A |
| Example 1 | | | | | | |
| Comparative | — | — | 1.5 | 0.2 | A | A |
| Example 2 | | | | | | |
| Comparative | — | — | — | 0.01 | A | A |
| Example 3 | | | | | | |
| Comparative | — | — | 1.5 | 0.1 | B | C |
| Example 4 | | | | | | |
| Comparative | a | 0.5 | — | 5 | A | A |
| Example 5 | | | | | | |
| Comparative | — | — | — | 1.2 | D | A |
| Example 6 | | | | | | |

### (2) Evaluation

The liquid developers thus obtained were evaluated in the following manner.

### (2-1) Fine Character Printing Capability

2-Point characters were formed on recording paper (high quality paper, LPCPPA4, produced by Seiko Epson Corp.) with the liquid developers obtained in Examples and Comparative Examples and thermally fixed thereon using an image forming apparatus shown in FIG. 1 and a fixing device shown in FIG. 4.

Thereafter, the resulting toner images (2-point characters) were visually evaluated based on the following five grades.

### A: 2-Point characters capable of being visually recognized significantly clearly

### B: 2-Point characters capable of being visually recognized clearly

### C: 2-Point characters capable of being visually recognized with slight blur

### D: 2-Point characters capable of being visually recognized with blur

### E: 2-Point characters not capable of being visually recognized

### (2-2) Environmental Stability (Long-Term Stability)

The liquid developers obtained in Examples and Comparative Examples were allowed to stand under an environment at a temperature of 35° C. and a relative humidity of 65% for 6 months. Thereafter, the state of the liquid developer was observed, and changes in viscosity, color, acid value and electric resistance before and after allowing to stand were evaluated based on the following five grades. The acid value was measured according to JIS K2501. The change in color of the liquid developer was evaluated visually. The viscosity was measured with a vibration viscometer according to JIS Z8809. The electric resistance was measured with Universal Electrometer MMA II-17B with an electrode for liquid LP-05 and a shield box P-618 (produced by Kawaguchi Electric Works, Co., Ltd.).

### A: Completely no change in viscosity, color, acid value and electric resistance found

### B: Substantially no change in viscosity, color, acid value and electric resistance found

### C: Slight change in viscosity, color, acid value and electric resistance found without problem upon using as liquid developer

### D: Change in viscosity, color, acid value and electric resistance clearly found

### E: Change in viscosity, color, acid value and electric resistance significantly found

### (2-3) Storage Stability

The liquid developers obtained in Examples and Comparative Examples were allowed to stand under an environment at a temperature of from 15 to 25° C. for 6 months. Thereafter, the state of the toner contained in the liquid developer was visually observed and evaluated based on the following five grades.

### A: Completely no floatage or precipitation due to aggregation of toner particles found

### B: Substantially no floatage or precipitation due to aggregation of toner particles found

### C: Slight floatage and precipitation due to aggregation of toner particles found without problem upon using as liquid developer

### D: Floatage and precipitation due to aggregation of toner particles clearly found

### E: Floatage and precipitation due to aggregation of toner particles significantly found

### (2-4) Fixing Strength

Images having a prescribed pattern were formed on recording paper (high quality paper, LPCPPA4, produced by Seiko Epson Corp.) with the liquid developers obtained in Examples and Comparative Examples using an image forming apparatus shown in FIG. 1. The images were then thermally fixed by using a fixing device shown in FIG. 4 with the temperature of the heat fixing roller set to 100° C.

Thereafter, the non-offset area was confirmed, and then the fixed image on the recording paper was rubbed with a rubber eraser (sand eraser, LION 261-11, produced by Lion Office Products Corp.) twice with a pressing load of 1.0 kgf. The remaining rate of the image density was measured with X-Rite Model 404, produced by X-Rite, Inc., and evaluated based on the following five grades.

### A: image density remaining rate of 95% or more

### B: image density remaining rate of 90% or more and less than 95%

### C: image density remaining rate of 80% or more and less than 90%

### D: image density remaining rate of 70% or more and less than 80%

### E: image density remaining rate of less than 70%

### (2-5) Peel Strength

Images having a prescribed pattern were formed on recording paper (high quality paper, LPCPPA4, produced by Seiko Epson Corp.) with the liquid developers obtained in Examples and Comparative Examples using an image forming apparatus shown in FIG. 1. The images were then thermally fixed by using a fixing device shown in FIG. 4 with the temperature of the heat fixing roller set to 180° C.

Thereafter, the non-offset area was confirmed, and then a plastic adhesive tape (Scotch Mending Tape 810-1-18, width: 10 mm, produced by Sumitomo 3M Ltd.) was adhered to the fixed image on the recording paper and then peeled off in a direction of 170° with respect to the plane of the recording paper at a speed of 5 cm/s. The remaining rate of the image density was measured with X-Rite Model 528, produced by X-Rite, Inc., and evaluated based on the following five grades.

### A: image density remaining rate of 95% or more

### B: image density remaining rate of 90% or more and less than 95%

### C: image density remaining rate of 80% or more and less than 90%

### D: image density remaining rate of 70% or more and less than 80%

### E: image density remaining rate of less than 70%

### (2-6) Durability

The liquid developers obtained in Examples and Comparative Examples were charged in an image forming apparatus obtained by removing the insulating liquid replenishing part from an image forming apparatus shown in FIG. 1, and a printing operation with a prescribed pattern (printed area: 5%) was continuously carried out for 8,000 sheets of a recording medium (A4 high quality paper, produced by Seiko Epson Corp.). The extent of image failure including thinning on the images formed was visually evaluated based on the following five grades. As the insulating liquid in the insulating liquid replenisher storing part in the image forming apparatus shown in FIG. 1, mixtures obtained by mixing the components of each of the liquid developers in Examples and Comparative Examples excluding the resin material and the colorant were used.

### A: No image failure including thinning found on images formed on all the 8,000 sheets

### B: Image failure including thinning firstly found on an image formed on from 7,000th to 7,999th sheets

### C: Image failure including thinning firstly found on an image formed on from 6,000th to 6,999th sheets

### D: Image failure including thinning firstly found on an image formed on from 4,000th to 5,999th sheets

### E: Image failure including thinning found on an image formed on from first to 3,999th sheets

The results are shown in Tables 3 and 4 along with the average particle diameters of the toner particles contained in the liquid developers obtained in Examples and Comparative Examples, and the standard deviations of the toner particles constituting the liquid developers.

TABLE 3

| | Evaluation of | | | | | | | Durability | |
|---|---|---|---|---|---|---|---|---|---|
| | particle diameter | | | | | | | With | Without |
| | Average | | Fine | | | | | insulating | insulating |
| | particle | Standard | character | | | | | liquid | liquid |
| | diameter | deviation | printing | Environmental | Storage | Fixing | Peel | replenishing | replenishing |
| | (μm) | (μm) | capability | stability | stability | strength | strength | part | part |
| Example 1 | 1.5 | 0.65 | A | A | A | A | A | A | A |
| Example 2 | 1.7 | 0.80 | A | A | A | A | A | A | A |
| Example 3 | 2.5 | 1.25 | B | A | B | B | B | A | A |
| Example 4 | 1.4 | 0.65 | A | B | A | A | A | B | C |
| Example 5 | 1.5 | 0.65 | A | A | A | A | A | A | A |
| Example 6 | 1.6 | 0.70 | A | A | A | A | A | A | A |
| Example 7 | 1.5 | 0.60 | A | A | A | B | B | A | A |
| Example 8 | 1.7 | 0.80 | A | B | B | A | A | B | C |
| Example 9 | 1.5 | 0.65 | A | B | A | A | A | B | C |
| Example 10 | 1.5 | 0.65 | A | B | B | A | A | B | C |
| Example 11 | 1.5 | 0.70 | A | A | A | B | A | A | A |
| Example 12 | 1.5 | 0.65 | A | A | A | A | A | A | A |
| Example 13 | 1.5 | 0.65 | A | B | A | A | A | B | A |
| Example 14 | 1.5 | 0.70 | A | A | C | B | B | A | B |
| Example 15 | 1.2 | 0.50 | A | A | A | B | B | A | A |
| Example 16 | 1.2 | 0.50 | A | B | A | A | A | B | C |
| Example 17 | 1.2 | 0.50 | A | A | A | B | B | A | A |
| Example 18 | 1.5 | 0.65 | A | E | D | C | C | E | E |
| Example 19 | 1.5 | 0.65 | A | E | E | C | C | E | E |
| Example 20 | 1.5 | 0.55 | A | D | D | E | E | D | D |
| Example 21 | 1.4 | 0.70 | A | B | B | B | C | B | B |

TABLE 4

| | Evaluation of | | | | | | | Durability | |
|---|---|---|---|---|---|---|---|---|---|
| | particle diameter | | | | | | | With | Without |
| | Average | | Fine | | | | | insulating | insulating |
| | particle | Standard | character | | | | | liquid | liquid |
| | diameter | deviation | printing | Environmental | Storage | Fixing | Peel | replenishing | replenishing |
| | (μm) | (μm) | capability | stability | stability | strength | strength | part | part |
| Example 22 | 1.5 | 0.65 | A | E | E | C | C | E | E |
| Example 23 | 1.5 | 0.65 | A | E | D | E | E | C | C |
| Example 24 | 1.5 | 0.65 | A | A | A | A | A | A | A |
| Example 25 | 1.7 | 0.65 | A | A | A | A | A | A | A |
| Example 26 | 2.5 | 1.25 | B | A | B | B | B | A | A |
| Example 27 | 1.4 | 0.60 | A | B | A | A | A | B | B |
| Example 28 | 1.5 | 0.65 | A | A | A | A | A | A | A |
| Example 29 | 1.7 | 0.80 | A | A | A | B | A | A | A |
| Example 30 | 1.5 | 0.65 | A | A | A | A | A | A | A |
| Example 31 | 1.6 | 0.70 | A | B | B | A | A | B | B |
| Example 32 | 1.5 | 0.65 | A | A | B | B | B | A | B |
| Example 33 | 1.2 | 0.50 | A | A | A | A | A | A | A |
| Example 34 | 1.2 | 0.50 | A | B | A | A | A | B | B |
| Example 35 | 1.2 | 0.50 | A | A | A | B | B | A | A |
| Example 36 | 1.3 | 0.65 | A | A | A | A | A | A | A |
| Example 37 | 1.3 | 0.65 | A | C | B | A | A | A | A |
| Comparative | 3.2 | 2.85 | E | B | D | E | E | E | E |
| Example 1 | | | | | | | | | |
| Comparative | 3.5 | 3.00 | E | E | E | D | D | E | E |
| Example 2 | | | | | | | | | |
| Comparative | 4.5 | 2.80 | E | D | D | E | E | C | C |
| Example 3 | | | | | | | | | |
| Comparative | 3.5 | 3.00 | E | E | E | C | D | D | E |
| Example 4 | | | | | | | | | |
| Comparative | 4.8 | 2.92 | E | D | D | E | E | C | C |
| Example 5 | | | | | | | | | |
| Comparative | 4.4 | 2.75 | E | E | D | D | D | E | E |
| Example 6 | | | | | | | | | |

It was understood from the results shown in Tables 3 and 4 that the toner particles contained in the liquid developers of Examples had sufficiently small particle diameters, and as a result, the toner images formed by using the liquid developers of Examples had excellent resolution. On the other hand, no satisfactory result was obtained with the liquid developers of Comparative Examples. Upon producing the liquid developers of Comparative Examples, the periods of time for pulverizing and crashing the toner material were prolonged, but the pulverization or crashing did not proceed, and the resulting toner particles contained a large amount of coarse particles.

The liquid developers of Examples 1 to 17 and 24 to 36 were excellent in environmental stability (long-term stability), storage stability, fixing property and durability.

The liquid developers of Examples 24, 28, 30 and 33 were evaluated for storage stability according to the item (2-3) Storage Stability except that the temperature, on which the liquid developers were allowed to stand, was increased to a high temperature (40 to 45° C.), but completely no floatage or precipitation due to aggregation of the toner particles was found after allowing to stand for 6 months. Furthermore, these liquid developers were evaluated for environmental stability according to the item (2-2) Environmental Stability except that the liquid developers were allowed to stand under the environment for further 6 month, but the same evaluation revealed that all the liquid developers exhibited no change in viscosity, color, acid value and electric resistance.

Production and evaluation of liquid developers were carried out in the same manner as above except that Pigment Red 122, Pigment Yellow 180 and carbon black (Printex L, produced by Degussa AG) were used instead of the cyan pigment, and as a results, the similar results as above were obtained.

The entire disclosure of Japanese Patent Application Nos: 2006-319339, filed Nov. 27, 2006 and 2006-319340, filed Nov. 27, 2006 and 2007-165602, filed Jun. 22, 2007 are expressly incorporated by reference herein.

What is claimed is:

1. An insulating liquid used for a liquid developer containing toner particles,
the insulating liquid comprising a fatty acid triglyceride and a fatty acid monoester,
the fatty acid triglyceride and the fatty acid monoester each containing an unsaturated fatty acid as a fatty acid component thereof, and
an alcohol component constituting the fatty acid monoester having an alkyl group having from 1 to 8 carbon atoms.

2. The insulating liquid as claimed in claim 1, wherein the alcohol component has a linear alkyl group having from 1 to 7 carbon atoms.

3. The insulating liquid as claimed in claim 1, wherein the alcohol component has a branched alkyl group having from 3 to 8 carbon atoms.

4. The insulating liquid as claimed in claim 3, wherein the fatty acid monoester contains a product produced through ester exchange reaction between a natural fat or oil and a secondary alcohol or a tertiary alcohol.

5. The insulating liquid as claimed in claim 1, wherein the fatty acid monoester contains an unsaturated fatty acid having from 14 to 22 carbon atoms as a fatty acid component.

6. The insulating liquid as claimed in claim 1, wherein a content X (% by weight) of the fatty acid triglyceride and a content Y (% by weight) of the fatty acid monoester in the insulating liquid satisfy relationship, 1≦X/Y≦19.

7. The insulating liquid as claimed in claim 1, wherein the insulating liquid further contains a hydrolysis inhibitor that inhibits hydrolysis of the fatty acid triglyceride and the fatty acid monoester.

8. The insulating liquid as claimed in claim 7, wherein the insulating liquid contains the hydrolysis inhibitor in an amount of from 0.01 to 5.0% by weight.

9. The insulating liquid as claimed in claim 7, wherein the hydrolysis inhibitor is a phenol phosphite compound.

10. A liquid developer comprising toner particles constituted mainly by a resin material and an insulating liquid,
the insulating liquid containing a fatty acid triglyceride and a fatty acid monoester,
the fatty acid triglyceride and the fatty acid monoester each containing an unsaturated fatty acid as a fatty acid component thereof, and
an alcohol component constituting the fatty acid monoester having an alkyl group having from 1 to 8 carbon atoms.

11. The liquid developer as claimed in claim 10, wherein the resin material constituting the toner particles has an acid value of from 0.1 to 15 mgKOH/g.

12. An image forming apparatus comprising:
a liquid developer storing part that stores a liquid developer;
a developing part that develops an image by using the liquid developer fed from the liquid developer storing part;
a transferring part that transfers the image formed in the developing part, onto a recording medium to form a transferred image;
a recovering part that recovers the liquid developer remaining in the developing part and/or the transferring part; a transporting part that transports the liquid developer recovered by the recovering part, to the liquid developer storing part; and
a fixing part that fixes the transferred image formed on the recording medium, onto the recording medium,
the liquid developer containing toner particles constituted mainly by a resin material and an insulating liquid,
the insulating liquid containing a fatty acid triglyceride and a fatty acid monoester,
the fatty acid triglyceride and the fatty acid monoester each containing an unsaturated fatty acid as a fatty acid component thereof, and
an alcohol component constituting the fatty acid monoester having an alkyl group having from 1 to 8 carbon atoms.

13. The image forming apparatus as claimed in claim 12, wherein the image forming apparatus further comprises an insulating liquid replenishing part that replenishes the insulating liquid to the liquid developer storing part.
